(19) United States
(12) Patent Application Publication
(10) Pub. No.: US 2024/0129295 A1
(43) Pub. Date: Apr. 18, 2024

(54) Attribute Verification To Enable Destination

(71) Applicant: Motional AD LLC, Boston, MA (US)

(72) Inventors: Bence Cserna, East Boston, MA (US); Alexander BROWN, Dover, NH (US); Kevin C. GALL, Dover, NH (US)

(21) Appl. No.: 18/085,096

(22) Filed: Dec. 20, 2022

Related U.S. Application Data
(60) Provisional application No. 63/416,286, filed on Oct. 14, 2022.

(51) Int. Cl. H04L 9/40

(52) U.S. Cl. CPC H04L 63/083

(57) ABSTRACT

Provided are methods for attribute verification to enable destination which can include obtaining a ride request requesting a ride for an item from a starting location to a destination, obtaining, credential data indicative of one or more credentials indicative of the item, verifying the one or more credentials indicative of the item, and generating, route data indicative of a route indicative of the ride by an autonomous vehicle based on the ride request. Systems and computer program products are also provided.

### CROSS-REFERENCE TO RELATED APPLICATIONS

The present application claims priority/benefit from U.S. Provisional Application No. 63/416,286, filed on Oct. 14, 2022, entitled “ATTRIBUTE VERIFICATION TO ENABLE DESTINATION,” which is herein incorporated by reference in its entirety.

### BACKGROUND

Transportation of items (e.g., people and goods) is a central aspect of modern life. An approach to transportation of items includes a person operating a vehicle who can then verify and monitor the items being transported. However, for autonomous vehicles (AVs) there is no human operator to verify and monitor items. Accordingly, due to the rise in prominence of AVs, there is a lack of integrated systems that can verify and monitor items being transported autonomously.

### BRIEF DESCRIPTION OF THE FIGURES

FIG. 1 is an example environment in which a vehicle including one or more components of an autonomous system can be implemented;

FIG. 2 is a diagram of one or more example systems of a vehicle including an autonomous system;

FIG. 3 is a diagram of components of one or more example devices and/or one or more example systems of FIGS. 1 and 2;

FIG. 4 is a diagram of certain components of an example autonomous system;

FIGS. 5A-5D are diagrams of an example implementation of a process for attribute verification to enable destination;

FIG. 6A-D are diagrams of example scenarios for attribute verification to enable destination; and

FIG. 7 is a diagram of an example implementation of a process for attribute verification to enable destination.

FIG. 8 is a flowchart of an example process for attribute verification to enable destination.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

“At least one,” and “one or more” includes a function being performed by one element, a function being performed by more than one element, e.g., in a distributed fashion, several functions being performed by one element, several functions being performed by several elements, or any combination of the above.”

Some embodiments of the present disclosure are described herein in connection with a threshold. As described herein, satisfying, such as meeting, a threshold can refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

### General Overview

In some aspects and/or embodiments, systems, methods, and computer program products described herein include and/or implement a method that includes obtaining, using at least one processor, a ride request requesting a ride for an item from a starting location to a destination. The method includes obtaining, using the at least one processor, credential data indicative of one or more credentials indicative of the item. The method includes verifying, using the at least one processor, the one or more credentials indicative of the item. The method includes, in response to successful verification of the one or more credentials indicative of the item, generating, using the at least one processor, route data indicative of a route indicative of the ride by an autonomous vehicle based on the ride request.

By virtue of the implementation of systems, methods, and computer program products described herein, techniques for attribute verification to reduce the number of interruptions while the security verification can be maintained and/or increased. The system is configured to ensure the AV item being transported by the AV can be monitored throughout the entirety of the ride. Therefore, an item can be transported from one person to another person securely using an AV. In other words, in some examples, the system is configured to ensure that the AV is a secure link in a chain of custody. The disclosed technique can reduce the need for periodic and/or continuous oversight by a remote AV operator and/or use of AVs without passengers to avoid tampering with goods, etc.

An approach to transporting passengers and/or goods included one or more people manually verifying passengers and/or goods. Advantageously, the disclosed method does not require manual verification checks carried out by humans and therefore allows for seamless transportation of passengers and/or goods. In other words, the disclosed method allows for quick and efficient transportation of passengers and/or goods. It may be appreciated that an advantage of the disclosed method is that, since a destination can be based on a verification of one or more credentials, the AV can automatically drive an item from a starting location to the destination without communicating the destination to a requestor of the ride and/or the item being a passenger. For example, a passenger may not need to know where he is going. The method can, in response to successful verification of one or more credentials of the passenger, generate route data of a route indicative of the ride by an AV based on the ride request without the passenger knowing the final destination of the ride.

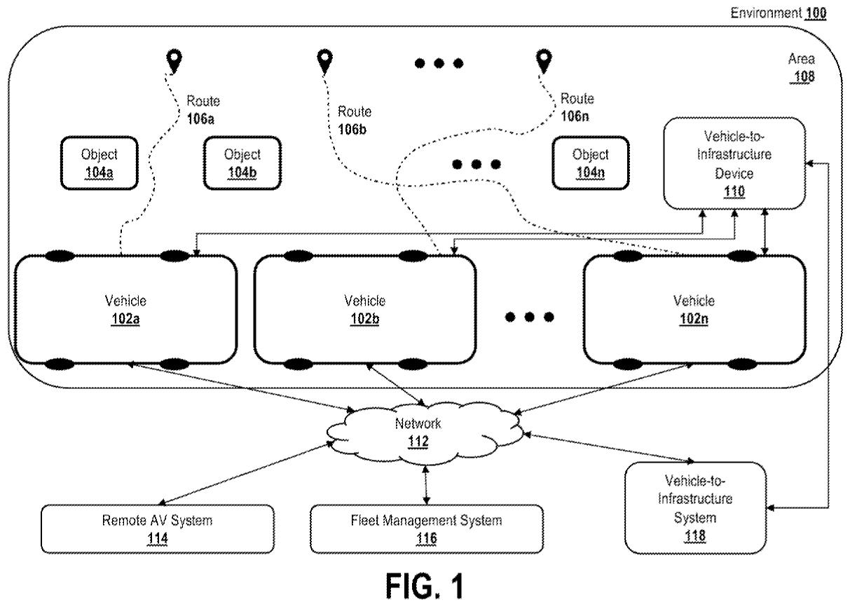

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

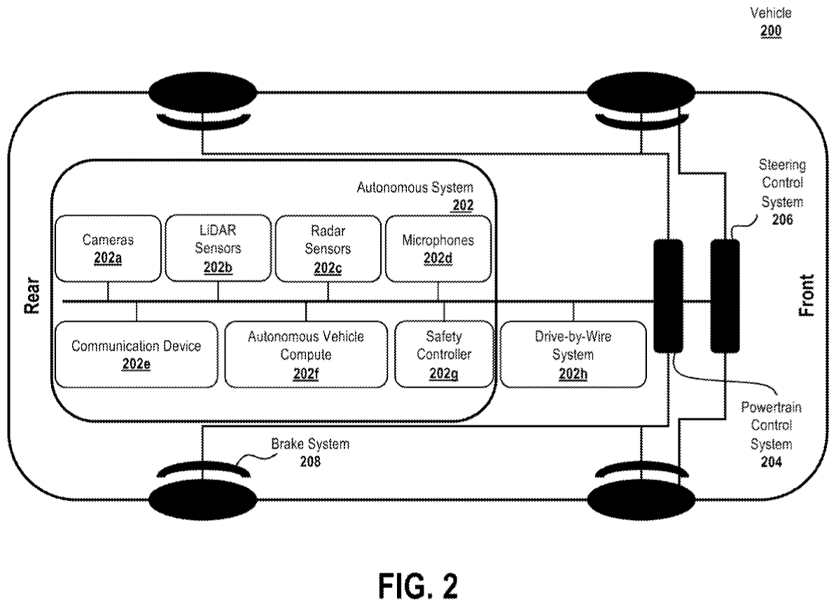

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and ends at a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure or Vehicle-to-Everything (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

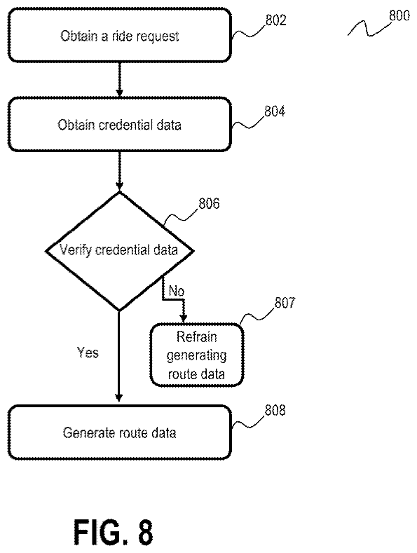

In some embodiments, device 300 is configured to execute software instructions of one or more steps of the disclosed method, as illustrated in FIG. 8.

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 (which may be the same as, or similar to vehicle 102 of FIG. 1) includes or is associated with autonomous system 202, powertrain control system 204, steering control system 206, and brake system 208. In some embodiments, vehicle 200 is the same as or similar to vehicle 102 (see FIG. 1). In some embodiments, autonomous system 202 is configured to confer vehicle 200 autonomous driving capability (e.g., implement at least one driving automation or maneuver-based function, feature, device, and/or the like that enable vehicle 200 to be partially or fully operated without human intervention including, without limitation, fully autonomous vehicles (e.g., vehicles that forego reliance on human intervention such as Level 5 ADS-operated vehicles), highly autonomous vehicles (e.g., vehicles that forego reliance on human intervention in certain situations such as Level 4 ADS-operated vehicles), conditional autonomous vehicles (e.g., vehicles that forego reliance on human intervention in limited situations such as Level 3 ADS-operated vehicles) and/or the like. In one embodiment, autonomous system 202 includes operational or tactical functionality required to operate vehicle 200 in on-road traffic and perform part or all of Dynamic Driving Task (DDT) on a sustained basis. In another embodiment, autonomous system 202 includes an Advanced Driver Assistance System (ADAS) that includes driver support features. Autonomous system 202 supports various levels of driving automation, ranging from no driving automation (e.g., Level 0) to full driving automation (e.g., Level 5). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, drive-by-wire (DBW) system 202h, and safety controller 202g.

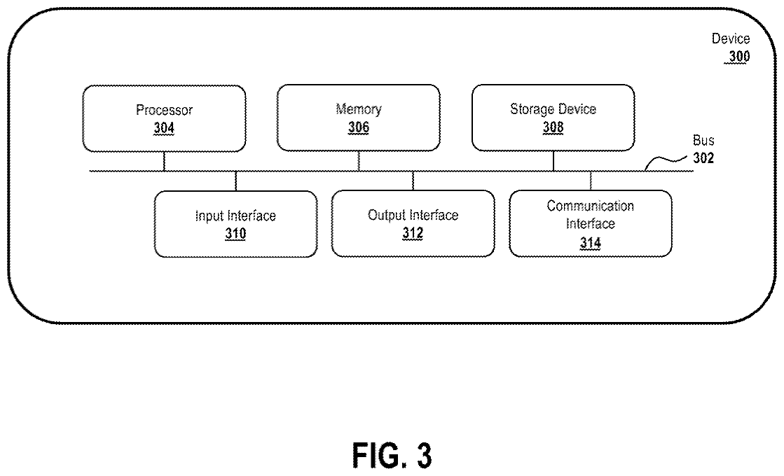

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a Charge-Coupled Device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD (Traffic Light Detection) data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Light Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e includes at least one device configured to be in communication with cameras 202a, LiDAR sensors 202b, radar sensors 202c, microphones 202d, autonomous vehicle compute 202f, safety controller 202g, and/or DBW (Drive-By-Wire) system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like), a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 make longitudinal vehicle motion, such as to start moving forward, stop moving forward, start moving backward, stop moving backward, accelerate in a direction, decelerate in a direction or to make lateral vehicle motion such as performing a left turn, performing a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate. In other words, steering control system 206 causes activities necessary for the regulation of the y-axis component of vehicle motion.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like. Although brake system 208 is illustrated to be located in the near side of vehicle 200 in FIG. 2, brake system 208 may be located anywhere in vehicle 200.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102), at least one device of remote AV system 114, fleet management system 116, V2I system 118, and/or one or more devices of network 112 (e.g., one or more devices of a system of network 112). In some embodiments, one or more devices of vehicles 102 (e.g., one or more devices of a system of vehicles 102 such as at least one device of remote AV system 114, fleet management system 116, and V2I system 118, and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some cases, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi© interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

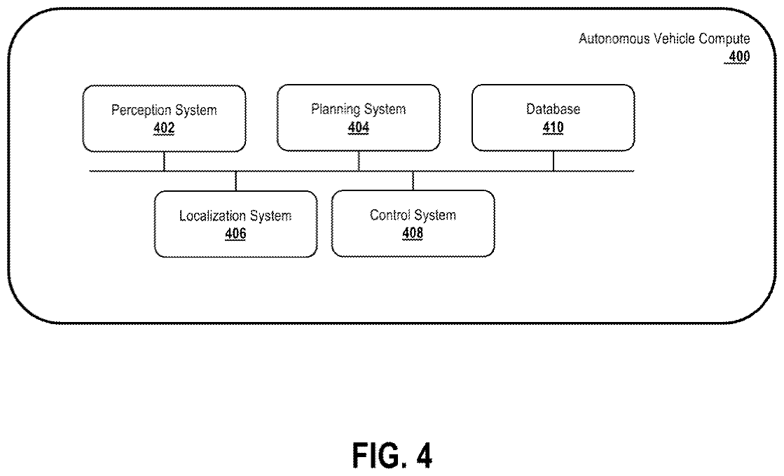

Referring now to FIG. 4, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits (ASICs), Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In other words, planning system 404 may perform tactical function-related tasks that are required to operate vehicle 102 in on-road traffic. Tactical efforts involve maneuvering the vehicle in traffic during a trip, including but not limited to deciding whether and when to overtake another vehicle, change lanes, or selecting an appropriate speed, acceleration, deacceleration, etc. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. For example, control system 408 is configured to perform operational functions such as a lateral vehicle motion control or a longitudinal vehicle motion control. The lateral vehicle motion control causes activities necessary for the regulation of the y-axis component of vehicle motion. The longitudinal vehicle motion control causes activities necessary for the regulation of the x-axis component of vehicle motion. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like).

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

The present disclosure relates to systems, and methods that provide secure verification of a requestor, and/or any goods to be transported by an autonomous vehicle to a destination. For example, upon authentication of the requester and/or of a loader party, and/or upon verification of the goods, the system provides the destination to the AV for goods to be transported. The system can check and ensure that the goods have not been tampered with in the transportation by the AV. The system can authenticate an unloader party and/or a passenger and/or goods before unloading.

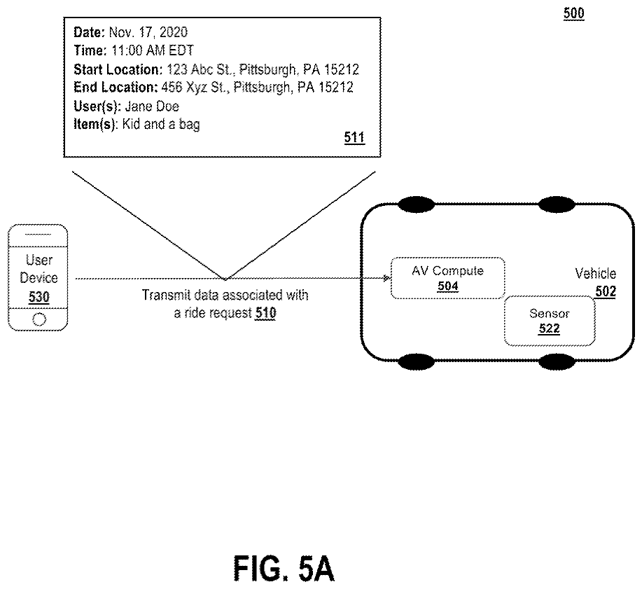

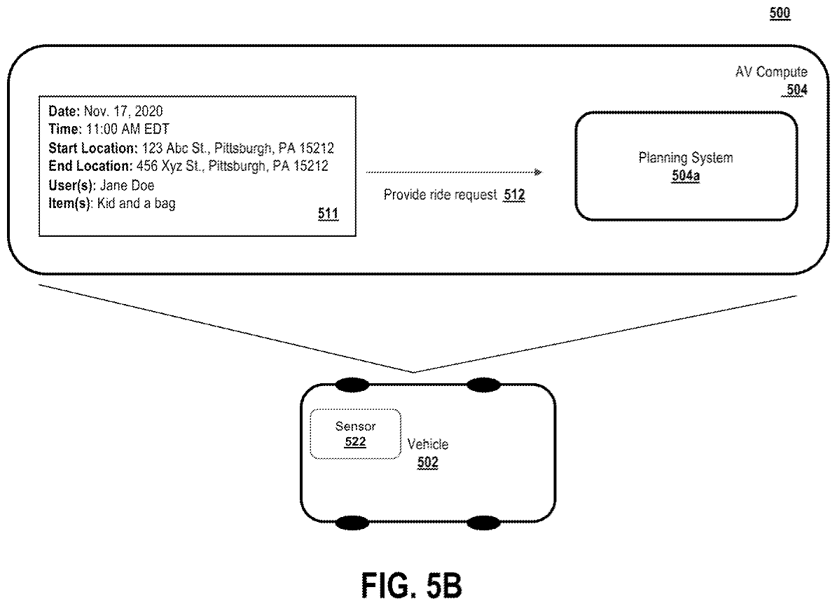

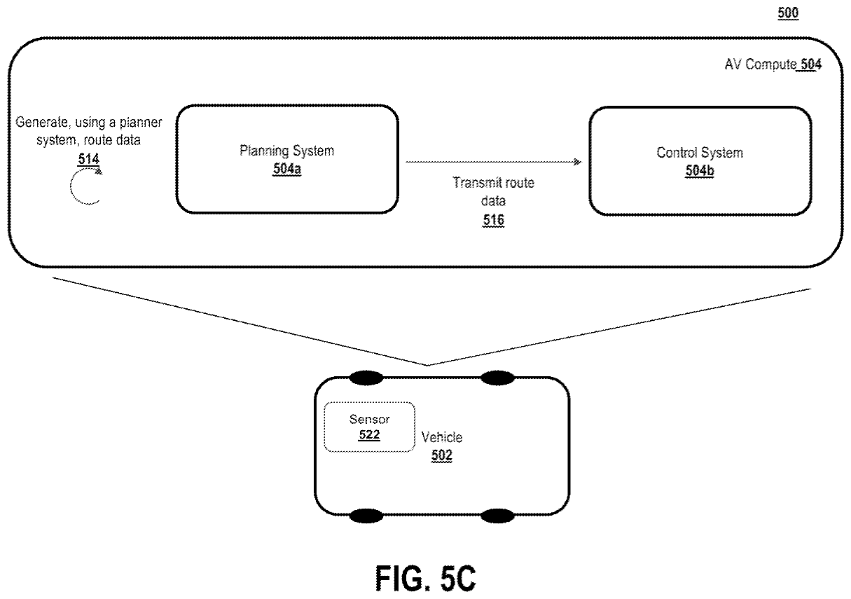

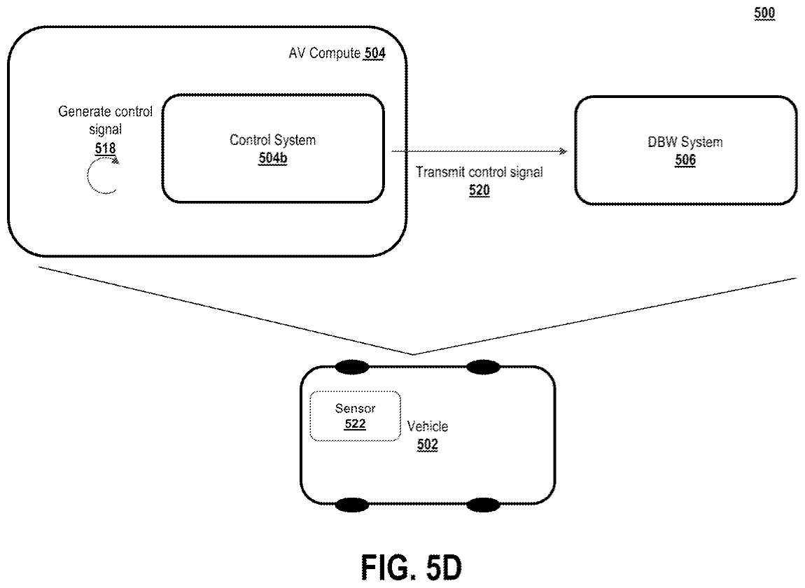

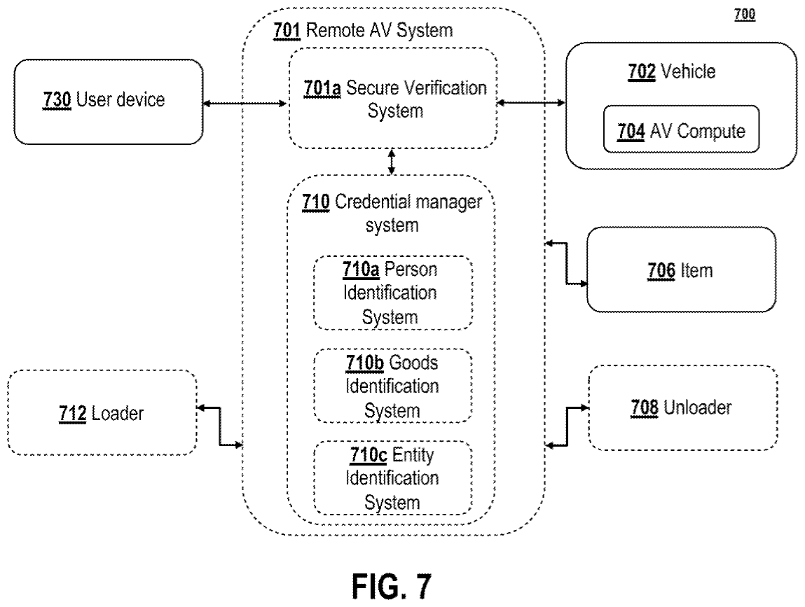

Referring now to FIGS. 5A-5D, illustrated is a diagram of a system 500 for systems and methods for attribute verification to enable destination. In other words, FIGS. 5A-5D illustrate an implementation of a process for attribute verification to enable destination, embodied by system 500. In one or more embodiments or examples, the system 500 is connected with and/or incorporated in a vehicle, such as vehicle 502 (e.g., an autonomous vehicle that is the same as, or similar to, vehicle 200 of FIG. 2, vehicle 702 of FIG. 7). In one or more embodiments or examples, system 500 is in communication with and/or a part of an AV (e.g., such as Autonomous System 202 illustrated in FIG. 2, device 300 of FIG. 3, and/or System 700 of FIG. 7), an AV system, an AV compute (such as AV compute 504, AV compute 202f of FIG. 2, AV compute 400 of FIG. 4, and/or AV compute 704 of FIG. 7), a remote AV system (such as remote AV system 114 of FIG. 1 and/or remote AV system 701 of FIG. 7), a fleet management system (such as fleet management system 116 of FIG. 1), and a V2I system (such as V2I system 118 of FIG. 1). The system 500 can be for operating an autonomous vehicle. Different operations and/or steps of the method and/or the system as disclosed herein may be performed at different devices, such as at the AV compute 504, at the user device 530, at the remote AV system 701, at the vehicle 702, at the user device 730, at the loader 712, and/or at the unloader 708 of FIG. 7. In one or more embodiments or examples, different operations and/or steps of the method and/or the system as disclosed herein may be performed on one or more servers.

In one or more embodiments or examples, the system 500 is in communication with one or more of: a device (such as device 300 of FIG. 3), a localization system (such as localization system 406 of FIG. 4), a planning system (such as the planning system 404 of FIG. 4), a perception system (such as the perception system 402 of FIG. 4), and a control system (such as the control system 408 of FIG. 4).

In one or more embodiments or examples, the system 500 includes one or more of: a planning system 504a, a perception system, and a control system that are the same as, or similar to, the planning system 404, the perception system 402, and the control system 408 of FIG. 4, respectively.

Referring now to FIGS. 5A-5D, diagrams of an example system 500 are disclosed. The system 500 includes a vehicle 502 including a planning system and a control system for determination of action. The vehicle 502 includes an AV compute 504. The AV compute 504 may be seen as a processing device. In other words, the AV compute 504 can include one or more processors.

In the example of FIG. 5A, the system 500 includes a user device 530 and the vehicle 502. In some examples, the user device 530 transmits data 511 indicative of a ride request 510 to the AV compute 504 of the vehicle 502. The ride request 510 can be requesting a ride for an item from a starting location to a destination. In some examples, the ride request 510 includes data 511, such as data indicative of a ride for an item from a starting location to a destination. The ride request 510 can include data 511 such as date data, time data, start location data (e.g., an address of a start location), end location data (e.g., an address of an end location), user data regarding a user (such as information regarding a requestor of a ride), and/or item data regarding an item. In the examples shown in FIGS. 5A-5B, the ride request 510 includes data 511 including date data indicative of a date being Nov. 17, 2020, time data indicative of a time being 11:00 AM EDT, start location data indicative of a start location being 123 Abc Street, Pittsburgh, PA 15212, end location data indicative of an end location being 456 Xyz Street, Pittsburgh, PA 15212, user data indicative of a user called Jane Doe, and item data indicative of an item being a kid and a bag. In some examples, the system 500 includes user device 530.

In the example of FIG. 5B, the AV compute 504 provides in 512 (e.g., is configured to provide) the ride request, such as ride request 510, to the planning system 504a. In some examples, the ride request includes data 511. In some examples, the AV compute 504 of vehicle 502 includes a planning system 504a.

In the example of FIG. 5C, the AV compute 504 includes a planning system 504a and a control system 504b. In FIG. 5C the AV compute 504 can generate (e.g., is configured to generate), using a planning system, route data 514 indicative of a route indicative of a ride by vehicle 502 based on the ride request. In one or more embodiments or examples, the route data is transmitted 516 to (e.g., inputted into) the planning system 504a for transmission to the control system 504b. In other words, the route data is provided and/or transmitted 516 from the planning system 504a to the control system 504b.

In the example of FIG. 5D, the AV compute 504 includes a control system 504b. In the example of FIG. 5D, the vehicle 502 includes a Drive-By-Wire (DBW) system 506. For example, the AV compute 504 generates (e.g., is configured to generate) a control signal 518. In some examples, the control signal is transmitted 520 from the AV compute 504, such as from the control system 504b, to the DBW system 506. In one or more embodiments or examples, the control signal is generated based on the route data. For example, the control signal includes information, such as data, indicative of instructions for executing a generated route of which the route data is indicative. In some examples, the DBW system 506 operates the vehicle 502 according to the generated route. The device disclosed herein which provides the route data can be the AV compute 504, such as the planning system, the planning system 504a, and/or the control system 504b. In some examples, the system 500 includes the DBW system 506.

Disclosed herein is a system 500. The system 500 incudes at least one processor. The system 500 includes at least one non-transitory computer readable medium storing instructions that, when executed by the at least one processor, cause the at least one processor to perform operations including obtaining, using at least one processor, a ride request requesting a ride for an item from a starting location to a destination. The operations include obtaining, using the at least one processor, credential data indicative of one or more credentials indicative of the item. The operations include verifying, using the at least one processor, the one or more credentials indicative of the item. The operations include, in response to successful verification of the one or more credentials indicative of the item, generating, using the at least one processor, route data indicative of a route indicative of the ride by an autonomous vehicle based on the ride request. The operations include, in response to unsuccessful verification of the one or more credentials indicative of the item, to refrain from generating route data indicative of a route indicative of the ride by an autonomous vehicle based on the ride request. In one or more embodiments or examples, the operations include, in response to unsuccessful verification of the one or more credentials indicative of the item, to refrain or forego from transmitting route data to the autonomous vehicle.

In other words, a processor (such as the AV compute 504) can be configured to obtain, for example from a user device 530 of a passenger, information indicative of a ride request. This ride request can include information indicative of a start location (e.g., the location of the passenger) and a destination. In some examples, a person can request a ride for transporting a good (e.g., food, documents, etc.). In some examples, the system 500 is configured such that a vehicle (such as the vehicle 502) drives to the start location indicative of the ride request. In some examples, the system 500 is then configured to obtain information, (e.g., a scan of a passport) such as via the AV compute 504, which the system 500 uses to verify the user. In some examples, the verification of the user includes communication between the vehicle 502 (such as using communication device 202e) and a third-party server. In some examples, when the person has been successfully verified, the system 500 is configured to generate a route (e.g., a ride route) including a start location and a destination.

In one or more embodiments or examples, the system 500 is configured to obtain a ride request requesting a ride for an item (such as item 706 of FIG. 7) from a starting location to a destination. The vehicle 502 can be configured to obtain the ride request from a user device 530 (e.g., a user equipment, such as a smartphone) indicative of a person. For example, the ride can be requested by a person from the user device 530 via an application and/or web browser. The person requesting the ride can be seen as a requestor. In other words, the system 500 can be configured to obtain a ride request from a requestor requesting a ride for an item from a starting location to a destination. In some examples, the ride includes transporting an item from a starting location to a destination. The system 500 can be configured to obtain a ride for one or more items. In other words, the system 500 can be configured to transport more than one item per ride. The ride may be seen as a verified ride for the item. The ride may be seen as a delivery of the item, such as a verified delivery of the item. The item can for example include one or more people and/or one or more goods. In some examples, the person can be a loader, unloader, a requestor, and/or a passenger. In some examples, the vehicle 502 can obtain a ride request requesting a ride for a passenger from a person different to the passenger. In other words, the requestor of the ride can be different to the passenger. The system 500 can, at and/or before the start of the ride, obtain the item from the loader. The loader is for example a person and/or device (e.g., robotic arm and/or loading robot) from which the vehicle 502 obtains the item. In other words, the loader can be a person and/or device which carries out the transition of moving the item from outside of vehicle 502 to inside of vehicle 502. The system 500 can, at and/or after the end of the ride, provide the item to the unloader. The unloader is for example a person and/or device (e.g., robotic arm and/or loading robot) to which the vehicle 502 provides the item. In other words, the loader can be a person and/or device which carries out the transition of moving the item from inside of vehicle 502, to outside of vehicle 502. In some examples, the unloader can be seen as a receiver (e.g., a person receiving the one or more items and/or goods). For example, the one or more items (such as goods) can include concert tickets, confidential documents, food packages, etc. The starting location can be seen as the location of the start of the ride. The destination can be seen as the location of the end of the ride. In some examples, when the item for which the ride has been requested is a person, the item can be seen as a passenger. It may be appreciated that the starting location can include a pick-up location, where the item is picked-up and transported to the destination by the vehicle 502.

In one or more embodiments or examples, the system 500 is configured to obtain using the at least one processor, credential data indicative of one or more credentials, the one or more credentials being indicative of the item. In one or more embodiments or examples, the system 500 is configured to obtain first credential data indicative of one or more first credentials, the one or more first credentials being indicative of the item. In other words, the one or more credential data can include first credential data indicative of one or more first credentials, the one or more first credentials indicative of the item. The first credential data may be seen as initial credential data indicative of the item at and/or before the start of the ride.

In one or more embodiments or examples, the credential data can include biometric data, identification data, sensor data, image data and/or label data. For example, obtaining credential data can include obtaining biometric data, identification data, sensor data, image data and/or label data. In some examples, biometric data includes iris scanner data, fingerprint data, face recognition data, weight data, and/or body shape data. In other words, the credentials indicative of the item can include one or more irises indicative of the item, one or more fingerprints indicative of the item, one or more faces indicative of the item, one or more weights indicative of the item, and/or one or more body shapes indicative of the item. In some examples, the credential data can be obtained using internal and/or external sensors of the vehicle 502. The biometric data can for example be obtained via one or more internal and/or external sensors. For example, the face recognition data can be obtained from one or more internal and/or external cameras (such as cameras 202a of FIG. 2). In some examples, identification data includes data indicative of government documents, ID devices, private keys, hash, blockchain. In some examples, the vehicle 502 can be configured to obtain identification data from the user device 530. For example, the vehicle 502 can be configured to verify an item by obtaining identification data (such as via Bluetooth and/or Near Field Communication (NFC)) from a user device (such as user device 530) indicative of the item. For example, the communication device 202e of vehicle 502 can be configured to communicate using Bluetooth and/or NFC with the user device 530 indicative of a person. For example, when the ride request is obtained for the item, the vehicle 502 can be configured to determine whether the user device 530 in the vicinity (such as within range of Bluetooth and/or NFC of the vehicle 502) is indicative of item for which the ride is requested. In some examples, sensor data includes LiDAR data (for example obtained by LiDAR sensors 202b of FIG. 2), 3D scanner data, heat data, and/or chemical verification data. In some examples, image data includes movement patterns. For example, image data includes movement patterns obtained using a machine learning model. In some examples, the vehicle 502 obtains image data using internal LiDAR sensors and/or 3D scanners. For example, the LiDAR sensors and/or 3D scanners are located at the trunk and/or outer surface (e.g., main area) of the vehicle 502. In some examples, the vehicle 502 is configured to verify the one or more goods by obtaining image data indicative of the shape of the one or more goods. In some examples, the vehicle 502 is configured to obtain image data (e.g., using cameras 202a of FIG. 2) indicative of the number of goods (e.g., number of objects). For example, when only one good (e.g., one bag of groceries) is allowed for the ride, the vehicle 502 can be configured to verify (such as using cameras 202a of FIG. 2) whether or not there is more than one good entering the vehicle 502. In some examples, label data includes one or more barcodes and/or one or more QR codes. The system 500 can be configured to obtain credential data indicative of the item inside the vehicle 502 and/or outside of the vehicle 502. In some examples, the system 500 can be configured to obtain the credential data using a dedicated secure verification system and/or device (such as a smart card reader, passport reader, etc.). In some examples, the dedicated secure verification system and/or device is a third-party device. In some examples, the dedicated secure verification system and/or device includes a third-party secure verification service integration (e.g., for verifying credential data). The secure verification system may be the secure verification system 701a of FIG. 7.

In some examples, the one or more credentials indicative of the item are credentials indicative of a person, such as a person taking the ride. In one or more embodiments or examples, the one or more credentials include initial credentials of a sender indicative of the item, such as indicative of a good. For example, the credentials can be credentials indicative of a passenger, loader, unloader, a sender, and/or requestor. For example, the credential indicative of the person can be a passport, fingerprint, keycard, etc. In some examples, the credentials can be credentials indicative of the one or more goods. For example, the credentials indicative of the one or more goods can be a label on a package, the weight of a package, etc.

In one or more embodiments or examples, the operations further include obtaining second credential data indicative of one or more second credentials, the one or more second credentials indicative of the item at or after an end of the ride. In one or more audio devices, embodiments or examples, the one or more second credentials are different from the one or more first credentials. For example, the first credentials can be indicative of a loader of the item and the second credentials can be indicative of an unloader of the item, where the loader and the unloader are different. In one or more embodiments or examples, the one or more second credentials are similar or identical to the one or more first credentials, for example to verify that the item at a start of the ride is the same as the item at the end of the ride. In one or more embodiments and examples, the system 500 is configured to obtain second credential data indicative of one or more second credentials, the one or more second credentials indicative of the item at or after an end of the ride. In some examples, the second credential data can be seen as credential data indicative of the item at and/or after the end of the ride. For example, the second credential data can be the credential data indicative of the unloading of item from the vehicle 502. In some examples, the second credential data can be biometric data, identification data, sensor data, image data and/or label data. For example, obtaining credential data indicative of one or more credentials indicative of the item can include obtaining biometric data, identification data, sensor data, image data and/or label data. The system 500 can be configured to obtain credential data indicative of the item inside the vehicle 502 and/or outside of the vehicle 502. In some examples, the one or more second credentials indicative of the item are credentials indicative of a person. For example, the second credentials can be credentials indicative of a passenger, loader, unloader and/or requestor. For example, the second credential indicative of the person can be a passport, fingerprint, keycard, etc. In some examples, the second credentials can be indicative of the one or more goods. For example, the second credentials indicative of the one or more goods can be a label on a package, the weight of a package, etc. The description related to the credentials, such as first credentials, may also apply to the description related to the second credentials.

In one or more embodiments or examples, the system 500 is configured to verify using the at least one processor, the one or more credentials indicative of the item. In one or more embodiments or examples, the system 500 verifies the one or more credentials indicative of the item by comparing the one or more credentials with a database of credentials and determining whether the one or more credentials matches in the database. In one or more embodiments or examples, the system 500 verifies the one or more credentials indicative of the item by determining whether the one or more credentials are present on the database. In one or more embodiments or examples, the system 500 verifies the one or more credentials by comparing the one or more credentials with credentials indicative of the ride request (e.g., an ID of the requester) and determining whether the one or more credentials matches. In some examples, the credentials can be seen as matching when the one or more credentials are the same as the credentials indicative of the ride request. In one or more embodiments or examples, the system 500 verifies the one or more credentials indicative of the item by authenticating one or more of: a good, a person entering the AV, a loader of the item, and an unloader of the item. In one or more embodiments or examples, the system 500 verifies the one or more credentials indicative of the item by using the vehicle 502 (such as the AV compute 504) and/or a server device comprising a secure verification system and/or a credential manager system (such as credential manager system 710 of FIG. 7). For example, the system 500 verifies the one or more credentials indicative of the item by using the vehicle 502 (such as the AV compute 504) and/or a remote AV system (e.g., a remote AV system on a server device), such as the remote AV system 701 of FIG. 7. In one or more embodiments or examples, the system 500 verifies the one or more credentials by verifying whether the one or more credentials satisfy a verification criterion. The verification criterion may be seen as a criterion indicative of a verification of the one or more credentials. The verification criterion may be seen as a criterion indicative of an authentication of credentials for authorizing and/or confirming the requested ride for the item and/or authorizing and/or confirming an action indicative of the requested ride for the item (such as a loading and/or an unloading of the item).

In one or more embodiments or examples, the system 500 verifies the one or more credentials by verifying whether the one or more credentials are in fact indicative of the item for which the ride has been requested. In one or more embodiments or examples, the system 500 verifies the one or more credentials by verifying whether the one or more credentials give authorization for the requested ride. In other words, the system 500 verifies whether the one or more credentials give authorization for the item to be transported from the starting location to the destination and/or handled before, during, and/or after the ride. For example, the system 500 verifies whether the one or more credentials match with one or more credentials indicative of the item for which the ride was requested.

In one or more embodiments or examples, the system 500 is configured to verify the one or more second credentials. The description related to the verification of the credentials, such as verification of the first credentials, can also apply to the description related to the verification of the second credentials.

In one or more embodiments or examples, the one or more credentials include an identifier indicative of at least one or more of: a person, one or more goods, and an entity. In other words, the one or more credentials include one or more of: a person identifier, one or more goods identifiers, and an entity identifier. In other words, verifying the one or more credentials includes verifying one or more of: personal credential data indicative of a person, goods credential data indicative of one or more goods, and entity credential data indicative of an entity. In other words, the system 500 is configured to verify one or more of: personal credential data indicative of a person, goods credential data indicative of one or more goods, and entity credential data indicative of an entity. In other words, the system 500 verifies the one or more credentials by verifying an identifier of a person, an identifier of one or more goods, and/or an identifier of an entity. For example, the system 500 verifies the one or more credentials by verifying a person identifier, one or more goods identifiers, and/or an entity identifier. For example, the identifier can be indicative of a loader, an unloader, a requestor and/or a passenger. In some examples, the identifier is a hologram, QR code, private key, hash, blockchain, etc. The one or more credentials can include an identifier indicative of a person in the form of government documents such as a passport and/or a driver's license. The system 500 may verify personal credential data indicative of a person by verifying an identifier of a government document such as a passport and/or a driver's license. In some examples, the system 500 is configured to obtain credential data including the identifier. The system 500 can be configured to obtain the identifier from the credential data to verify the credentials. For example, when the identifier is a barcode the system 500 can be configured to obtain, for example using an optical scanner, credential data indicative of the credential by scanning the barcode. The system 500 can then verify whether the barcode matches a valid barcode of the item for which the ride was requested. For example, the system 500 can be configured to obtain, for example using cameras 202a of FIG. 2, an image of the identifier. The obtained image including the identifier can be seen as credential data. In some examples, the one or more goods can be seen as any non-human items (e.g., food, pet, confidential documents, etc.) for which the ride has been requested. An entity can for example include a restaurant, a firm, and/or a company. In some examples, the system 500 is configured to obtain personal credential data for the purpose of identifying and/or verifying the identity of a person indicative of the item for which the ride is requested. Personal credential data can include biometric data. In some examples, the system 500 can be configured to obtain the personal credential data indicative of a person by obtaining biometric data (biometric identification, e.g., with a biometric sensor). The system 500 may be configured to obtain biometric data to verify the credentials by facial recognition, fingerprint recognition, and/or weight recognition. Personal credential data can include identification data (e.g., for identification of the loader, such as a sender, and/or an unloader of goods). In some examples, the loader can load food into the vehicle 502. Therefore, the system 500 can be configured to obtain personal credential data indicative of a credential (e.g., passport, driver's license, identification fob indicative of a restaurant, etc.) of the loader. An unloader can then unload the food delivered by the vehicle 502. The unloader can for example be the requester of the ride and/or a delivery person. The system 500 may thereby provide food delivery safety. In some examples, the system 500 is configured to obtain goods credential data for purpose of identifying and/or verifying goods for which the ride is requested. In some examples, the goods credential data can for example include a QR code on a cardboard box. In some examples, the system 500 is configured to obtain entity credential data for the purpose of identifying and/or verifying the entity indicative of the item for which the ride is requested. For example, when the item is a food package, the entity credential data can be an employee keycard of the restaurant indicative of the food package.

In one or more embodiments or examples, the system 500 is configured to verify the one or more credentials by verifying one or more first credentials indicative of the item before and/or at a start of the ride. To verify the one or more first credentials can be seen as a preliminary check to ensure that the credentials (such as first credentials) are verified before and/or at the start of the ride. In one or more embodiments or examples, the first credentials include one or more of: health credentials, access credentials, travel credentials, good credentials, and identification credentials. In one or more embodiments or examples, the system 500 is configured to verify the one or more credentials by verifying one or more of: health credentials, access credentials, travel credentials, good credentials, and identification credentials.

In some examples, the one or more first credentials can include health credentials indicative of credentials indicative of a health of the item. In other words, the health credentials can allow to identify and/or verify health information indicative of the item. For example, a health credential can be a covid test certificate and/or a vaccine passport. The system 500 can be configured to verify the one or more first credentials (such as a health credential) before and/or at the start of a ride. For example, the system 500 can be configured to verify the one or more first credentials (such as a health credential) before enabling a ride to a certain location. For example, when a location, such as a destination, requires a vaccine passport, the system 500 can be configured to enable access to the location and/or destination only when the vaccine passport has been successfully verified.

In some examples, the one or more first credentials can include access credentials indicative of credentials indicative of an access, such as credentials indicative of an access right of the item. In other words, the access credentials can be seen as an access right and/or access authorization indicative of the credentials of the item. In other words, the access credentials can allow to identify and/or verify access information indicative of the item. In other words, the system 500 can be configured such that the locations accessible to the item riding in vehicle 502 are based on the access credentials. For example, when the requested destination of a ride is a VIP entrance, the system 500 is configured to verify the access credentials to determine whether the item is authorized to access the VIP entrance. In some examples, when the system 500 has successfully verified the access credentials to be authorized to access the VIP entrance, the system 500 can be configured to generate route data for a ride to the VIP entrance. In one or more embodiments or examples, the system 500 can be configured to provide the credential data indicative of the access credentials indicative of the item to an external server. The external server can for example be communicatively coupled with an automated entrance gate to the VIP entrance. In some examples, the automated entrance gate opens in response to receiving (e.g., from the vehicle 502) the successfully verified credential data indicative of the access credentials.

In some examples, the one or more first credentials can include travel credentials indicative of credentials indicative of travel, such as credentials indicative of a travel of the item. In other words, the travel credentials can allow to identify and/or verify travel information indicative of the item. In other words, the first credentials may include travel credentials required for a border crossing (e.g., passport and/or a visa). For example, travel credentials can include a ticket, such as a train ticket and/or a plane ticket. In one or more embodiments or examples, the system 500 can be configured to verify a plane ticket before and/or at the start of a ride requested for an airport, e.g., to verify that the plane ticket is valid for the requested ride for the item.

In some examples, the one or more first credentials can include good credentials indicative of credentials indicative of a good. In other words, the good credentials can allow to identify and/or verify a good. The good credentials can for example include a label and/or a tag on the good (e.g., on the item).

In some examples, the one or more first credentials can include identification credentials indicative of credentials indicative of an identity, such as an identity of the item. The identification credentials can for example include credentials indicative of an identity of a person (e.g., loader, unloader, requestor and/or passenger).

In one or more embodiments or examples, the system 500 is configured to verify one or more first credentials indicative of the item before and/or at a start of the ride. In some examples, the first credential data can be seen as credential data indicative of one or more first credentials indicative of the item before and/or at a start of a ride. In some examples, first credential data is indicative of one or more first credentials indicative of the item. In some examples, the system 500 is configured to verify the one or more first credentials using the AV compute 504 (such as using the database 410 of FIG. 4). In some examples, the system 500 is configured to verify the one or more first credentials by providing the one or more first credential data to an external server (such as a server indicative of verification services, such as the secure verification system 701a of FIG. 7). In some examples, a verification service indicative of the one or more first credentials includes an external (such as external to the vehicle 502) server with which the vehicle 502 can be configured to communicate (e.g., provide data to and/or obtain data from). For example, the network 112 of FIG. 1 can include a server indicative of a verification service for verifying the one or more first credentials. Alternatively or additionally, the remote AV system 114 (such as remote AV system 701 of FIG. 7) can include a server indicative of a verification service (such as secure verification system 701A of FIG. 7) for verifying the one or more first credentials. In some examples, the system 500 verifies the one or more first credentials by providing first credential data indicative of the one or more first credentials from the vehicle 502 to a third-party (e.g., a server indicative of the first credentials) capable of independently (such as independently to the vehicle 502) verifying the one or more first credentials. The system 500 can be configured to communicate with the third-party verification server, e.g., via the remote AV system (such as the remote AV system 114 of FIG. 1 and/or the remote AV system 701 of FIG. 7) and/or via the vehicle 502. In some examples, the verification service is a secure verification service, such as secure verification system. The verification service indicative of the one or more first credentials can for example include one or more databases including first credential data indicative of one or more valid first credentials. In some examples, when the first credential data indicative of the one or more first credentials indicative of the item matches (e.g., is the same as) first credential data of one or more valid first credentials stored on the database of the verification service, the one or more first credentials indicative of item are successfully verified.

In one or more embodiments or examples, the system 500 is configured to generate the route data by generating the route data based on the one or more first credentials. In one or more embodiments or examples, the system 500 generates the route data based on one or more of: health credentials, access credentials, travel credentials, good credentials, and identification credentials. In one or more embodiments or examples, the system 500 is configured to generate the route data in response to successful verification of the first credentials.

In one or more embodiments or examples, the system 500 is configured to generate the route data by generating route data including a destination (such as an intermediate destination and/or a final destination) indicative of the one or more first credentials. In some examples, the intermediate destination is a destination after the start of the ride and before the end of the ride. For example, the system 500 generates, based on the one or more first credentials, route data indicative of a route including one or more stops (e.g., intermediate destinations). For example, when the ride includes crossing a border, the vehicle 502 can, based on the identification credentials (e.g., passport) indicative of the passenger, generate route data indicative of a route including one or more border checkpoints. In one or more embodiments or examples, the system 500 is configured to generate route data based on access credentials. For example, the first credential data is indicative of an access credential (such as a VIP ticket for a concert) indicative of a passenger. In some examples, the VIP ticket is indicative of a VIP entrance to the concert venue. In some examples, the vehicle 502 is configured to generate route data based on the concert ticket. For example, the vehicle 502 generates route data indicative of a route including a final destination being a VIP entrance to the concert venue.

In one or more embodiments or examples, the first credential data can be indicative of a travel credential (e.g., a plane ticket) indicative of a passenger. In some examples, the plane ticket can indicate a terminal at an airport (such as the terminal of departure for the flight indicative of the plane ticket of the passenger). In some examples, the system 500 is configured to generate route data based on the travel credentials. For example, the vehicle 502 can generate (such as using the AV compute 504) route data based on the plane ticket. In some examples, the route data generated by the vehicle 502 is indicative of a route including the terminal of departure for the flight indicated by the plane ticket indicative of the passenger. In some examples, the final destination of the ride is the terminal of departure for the plane indicated by the plane ticket indicative of the passenger.

In one or more embodiments or examples, the system 500 is configured to generate the route data by updating a final destination of the ride based on the one or more first credentials. In some examples, the final destination can be seen as a precise drop-off point for the item at the end of the ride. In some examples, the destination includes the final destination (e.g., the destination can be an area containing the final destination). In one or more embodiments or examples, the system 500 is configured to generate the route data by generating route data including a final destination indicative of the one or more first credentials. For the above example of the concert ticket, the vehicle 502 can generate route data indicative of a route including a final destination being a VIP entrance to the concert venue. For the above example of the plane ticket, the vehicle 502 can generate route data indicative of a route including a final destination being the terminal of departure for the flight indicated by the plane ticket indicative of the passenger.

In one or more embodiments or examples, verifying the one or more first credentials includes verifying one or more of: biometric data, identification data, sensor data, image data, and label data. In one or more embodiments or examples, the system 500 is configured to verify the one or more first credentials by verifying one or more of: biometric data, identification data, sensor data, image data, and label data.

For example, the system 500 is configured to verify biometric data obtained via one or more internal and/or external sensors of the vehicle 502. For example, the system 500 is configured to verify face recognition data. In some examples, the system 500 is configured to verify identification data, such as data indicative of government documents, ID devices, private keys, hash, blockchain. In some examples, the system 500 is configured to verify identification data obtained from the user device 530. For example, the system 500, such as the vehicle 502, is configured to verify an item by obtaining identification data (such as via Bluetooth and/or Near Field Communication (NFC)) from user device 530 indicative of the item. In some examples, the system 500 is configured to verify image data including movement patterns (such as image data obtained by cameras 202a of FIG. 2). For example, the system 500 is configured to verify image data including movement patterns by using a machine learning model. In some examples, the system 500 is configured to verify label data including one or more barcodes and/or one or more QR codes.

In some examples, the system 500 is configured to receive one or more first credentials with the ride request. In other words, the ride request provided to the vehicle 502 can include one or more first credentials. In some examples, the system 500 is configured to verify the one or more first credentials by comparing the first credential data indicative of one or more first credentials indicative of the item against the first credential data included in the ride request obtained by the vehicle 502. In other words, the system 500 is configured to verify the first credential data by comparing the first credential data obtained directly from the item by the vehicle 502 against the first credential data included in the ride request obtained by the system 500 and/or the vehicle 502. In some examples, when the first credential data obtained directly from the item by the vehicle 502 matches (e.g., is the same as) the first credential data included in the ride request obtained by the vehicle 502, the one or more first credentials indicative of the item are successfully verified.

In one or more embodiments or examples, verifying the one or more first credentials includes authenticating a person, verifying integrity of a good, or verifying origin of a good. In one or more embodiments or examples, the system 500 is configured to verify the one or more first credentials by authenticating a person, verifying integrity of a good, and/or verifying origin of a good. In some examples, authenticating a person includes verifying the identity of a person. In some examples, the system 500 is configured to verify integrity of a good by verifying whether the good is broken or intact and/or whether the good has been tampered with during the ride. In one or more embodiments or examples, the system 500 is configured to verify integrity of a good by verifying item data (such as good data) indicative of an integrity of the item (such as good) at a start of the ride, during the ride, and/or at end of the ride. In some examples, the system 500 is configured to verify origin of a good by verifying whether the origin of the good indicative of the first credentials matches an origin of the good (such as item) that the ride was requested for. For example, the system 500 is configured to verify whether the location where the first credentials were obtained at matches a starting location for the good (such as item) that the ride was requested for. In one or more embodiments or examples, the system 500 is configured to verify origin of a good by verifying item data (such as good data) indicative of an origin of the item (such as good) at a start of the ride, during the ride, and/or at end of the ride.

In one or more embodiments or examples, the system 500 is configured to generate, in response to successful verification of the one or more credentials indicative of the item, using the at least one processor, route data indicative of a route indicative of the ride by an autonomous vehicle based on the ride request. In one or more embodiments or examples, the system 500 is configured to, in response to the one or more credentials satisfying the verification criterion, generate route data indicative of a route indicative of the ride by an autonomous vehicle based on the ride request. In other words, the system 500 is configured to generate, in response to successful verification of the one or more credentials indicative of the item, control data based on the route data and cause the vehicle 502 to operate according to the control data. For example, in response to successful verification of the one or more credentials indicative of the item the system 500 is configured to cause the vehicle 502 to start the ride based on the route data and/or the control data. In one or more embodiments or examples, in response to a determination that the one or more credentials match the one or more credentials present on the database, the system 500 is configured to generate route data indicative of a route indicative of the ride by an autonomous vehicle based on the ride request. In one or more embodiments or examples, in response to a determination that the one or more credentials match the credentials indicative of the ride request, the system 500 is configured to generate route data indicative of a route indicative of the ride by an autonomous vehicle based on the ride request. In some examples, credentials that have been successfully verified can be seen as valid credentials. In one or more embodiments or examples, credentials that have been successfully verified can be seen as giving authorization for the item to be transported from the starting location to the destination and/or handled before, during, and/or after the ride (such as a loading and/or an unloading of the item).

In one or more embodiments or examples, the system 500 is configured to transmit, via an interface, the route data to the autonomous vehicle, such as vehicle 502.

In one or more embodiments or examples, the system 500 is configured to forego the transmission of the route data to the autonomous vehicle based on the verification of the one or more credentials. In other words, in response to unsuccessful verification of the one or more credentials, the system 500 is configured to forego the transmission of the route data to the autonomous vehicle.

In one or more embodiments or examples, the system 500 is configured to generate the route data in response to obtaining the ride request. In other words, the system 500 can be configured such that credential data is not required to generate route data. In one or more embodiments or examples, the system 500 is configured to generate the route data indicative of a route from a current location of the vehicle 502 to a starting location of the ride.

In some examples, route data is generated using a planning system. In some examples, the system 500 is configured to operate the vehicle 502 based on the route data. In other words, the AV compute 504 is configured to generate a control signal 518 for operation of the vehicle 502 based on the route data. In some examples, the route begins at a starting location and ends at a destination. In some examples, the route begins at a current location of the vehicle 502, then to the starting location, and ends at a destination (such as a final destination).

In one or more embodiments or examples, the system 500 is configured to provide the route data to cause the vehicle 502 to operate based on the verification of the one or more credentials. In other words, once the one or more credentials (such as the one or more first credentials) have been successfully verified, the system 500 can be configured to provide and/or transmit route data 516 to the control system, such as via the planning system 504a. For example, the AV compute 504 generates a control signal 518 based on the received route data. In some examples, the control signal is transmitted 520 to the DBW system 506 to cause the vehicle 502 to operate based on the route data. In one or more embodiments or examples, the control signal is transmitted 520 from the AV compute 504, such as from the control system 504b, to the DBW system 506.

In one or more embodiments or examples, the system 500 is configured to trigger, based on the route data, a start of the ride towards the destination upon successful verification of the one or more credentials. In one or more embodiments or examples, the system 500 is configured to trigger, based on the route data, a start of the ride towards the destination in response to successful verification of the one or more credentials. In other words, once the one or more credentials have been successfully verified, the system 500 can be configured to generate control data for the vehicle 502 to begin driving (e.g., start the ride) towards the destination. For example, the system 500 can be configured to trigger a start of the ride towards the destination based on the control data generated by the control system 504b. In some examples, triggering of the start of the ride includes transmitting a control signal (such as transmitting control signal 520 of FIG. 5D) to a DBW system (such as the DBW system 506 of FIG. 5D) for controlling of the AV 604. In some examples, the control data is based on the route data. In some examples, the start of the ride can be seen as the moment the vehicle 502 began transporting the item towards the destination.

In one or more embodiments or examples, the operations further include, in response to successful verification of the one or more second credentials, generating, based on the one or more second credentials, control data for controlling the autonomous vehicle. In some examples, the control data when executed can cause the AV to operate based on the successful verification of the second credentials. In some examples, the generated control signal 518 and/or the transmitted control signal 520 can be based on the control data generated based on the one or more second credentials. In some examples, the system 500 is configured to transmit the control signal 520 based on control data indicative of ending instructions to the vehicle 502. In some examples, the ending instructions can be indicative of an end of the ride. For example, the control data can include ending instructions indicative of one or more operations that the vehicle 502 is to perform at the end of the ride. For example, the system 500 can generate control data indicative of an unlocking of one or more doors and/or trunk of the vehicle 502 based on the second credentials, e.g., to allow an unloading of the item. In some examples, the system 500 can generate control data indicative of a maneuver for parking the vehicle 502 at the destination based on the second credentials. In one or more embodiments or examples, the operations further include, in response to unsuccessful verification of the one or more second credentials, to refrain from generating control data for controlling the autonomous vehicle.

In one or more embodiments or examples, the system 500 is configured to generate control data for controlling access to the autonomous vehicle. In some examples, the system 500 generates control data indicative of a granted access and/or a restricted access. In some examples, the system 500 is configured to generate control data for controlling access (e.g., granting access) to the vehicle 502 by generating control data to unlock the doors and/or trunk (such as front trunk and/or a rear trunk) of the vehicle 502, open the doors and/or trunk (such as frunk) of the vehicle 502 and/or bring the vehicle 502 to a halt. In some examples, the system 500 is configured to generate control data for controlling access (e.g., restricting access) to the vehicle 502 by generating control data to lock the doors and/or trunk (such as front trunk and/or a rear trunk) of the vehicle 502, close the doors and/or trunk (such as frunk) of the vehicle 502. In some examples, the system 500 is configured to generate control data for controlling access to the vehicle 502 by controlling access to the vehicle 502 for delivering a person and/or goods.

In one or more embodiments or examples, the system 500 is configured to generate control data for controlling navigation of the autonomous vehicle. In some examples, operation of the vehicle 502 includes navigation of the vehicle 502. In some examples, the system 500 is configured to generate control data for controlling the navigation of the vehicle 502 by generating control data for causing the vehicle 502 to ride from the starting location to the destination. In one or more embodiments or examples, the system 500 is configured to generate control data for controlling navigation of the vehicle 502 using the control system 504b. In some examples, the route indicative of the ride by an autonomous vehicle includes a border crossing. In some examples, a ride including a border crossing can require a manual check of the one or more credentials indicative of the item (e.g., a passenger). In some examples, AVs, such as vehicle 502, are randomly selected (e.g., via the AV compute 504, via the remote AV system 114 of FIG. 1 and/or via the remote AV system 701 of FIG. 7) for a manual check (e.g., a manual check of the one or more credentials). In some examples, the system 500 is configured to generate control data for controlling the navigation of the vehicle 502 by generating control data for rerouting the vehicle 502 to a checkpoint (e.g., a border checkpoint for manual credential check).

In one or more embodiments or examples, the operations further include determining, based on the verification of the one or more second credentials, an authentication status. In some examples, the authentication status can be a status representing an authentication of credentials associated with the item, such as first credentials and/or second credentials. The authentication status can be indicative of a successful authentication, a partly successful authentication, or an unsuccessful authentication. In one or more embodiments or examples, the operations further include providing the authentication status to a device, such as to a remote AV system, e.g., remote AV system 701 of FIG. 7, and/or to a server for secure verification and/or a ride service. In one or more embodiments or examples, the system 500 can be configured to provide the authentication status to a device, such as to a user device, such as to the user device 530 of FIG. 5A, the user device 730, the loader 712, and/or the unloader 708 of FIG. 7. For example, the system 500 can be configured to provide the authentication status from a credential manager system, such as from the credential manager system 710 of FIG. 7, to a secure verification system, such as to the secure verification system 701a of FIG. 7. In some examples, the system 500 is configured to provide the authentication status by transmitting the authentication status, such as transmitting the authentication status from a credential manager system, such as from the credential manager system 710 of FIG. 7, to a secure verification system, such as to the secure verification system 701a of FIG. 7. For example, the verification status can be transmitted via an interface of the credential manager system, such as an interface of the credential manager system 710 of FIG. 7, to an interface of a secure verification system, such as an interface of the secure verification system 701a of FIG. 7.

In one or more embodiments or examples, the system 500 is configured to obtain monitoring data indicative of a monitoring of the item during the ride. Monitoring data can for example include image data (e.g., obtained by cameras 202a of FIG. 2). In some examples, the monitoring data includes heat data and/or chemical data for chemical verification of the item. For example, chemical data refers to a chemical makeup of the item and/or detectable chemical attributes. For example, if an item is expected to be transported cold in dry ice, perhaps the system could detect the presence of elevated carbon dioxide. In one or more embodiments or examples, the item is a sensitive item (e.g., a confidential item). The monitoring data can therefore be indicative of the sensitive item, such as a confidential item. In some examples, the monitoring data can be monitored (e.g., by Remote Vehicle Assistance (RVA) personnel) throughout the ride. In one or more embodiments or examples, the system 500 is configured to obtain monitoring data indicative of a monitoring of the item during the ride such that a chain of custody for the item (e.g., a sensitive item) remains unbroken throughout the ride. In some examples, the system 500 is configured to generate (such as using AV compute 504) a log indicative of the chain of custody of an item. The monitoring data can be seen as data indicative of a state of the item over time during the ride. For example, the monitoring data can include sensor data such as image data from one or more cameras, temperature data from one or more heat cameras, and/or chemical data from one or more chemical sensors. In one or more embodiments or examples, the system 500 can be configured to avoid blind spots in monitoring of the item, such as visual blind spots, by having sensors configured to monitor the item anywhere in the vehicle 502. In one or more embodiments or examples, the system 500 is configured to determine an item status based on the monitoring data. The system 500 can be configured to determine the item status at the vehicle 502 and/or at a remote AV system, such as remote AV system 701 of FIG. 7. The remote AV system can be configured to determine the item status based on monitoring data obtained from the vehicle 502. In some examples, the item status is indicative of the state (e.g., the condition) of the item, such as the state of the item during the ride. In one or more embodiments or examples, the system 500 is configured to provide the item status to a device, such as by providing the monitoring data. In one or more embodiments or examples, the system 500 is configured to provide the item status to a device, e.g., by providing the item status from the vehicle 502, such as AV compute 504, to a ride service, such as a ride service on a remote AV system, e.g., remote AV system 701 of FIG. 7. In one or more embodiments or examples, the system 500 can be configured to provide the item status to a server for secure verification of the item status, e.g., a server included in the remote AV system. For example, the system 500 can be configured to provide the item status from the remote AV system (such as remote AV system 701 of FIG. 7) and/or the vehicle 502 (such as vehicle 702 of FIG. 7) to a user device, such as the user device 530 of FIG. 5A, the user device 730 of FIG. 7, the loader 712, and/or the unloader 708 of FIG. 7. In some examples, the system 500 is configured to provide the item status by transmitting the item status, such as transmitting the item status from the secure verification system (such as secure verification system 701a of FIG. 7) and/or the vehicle 502 (such as vehicle 702) to the ride requestor, e.g., via a user device of the ride requestor. The item status can for example be transmitted via an interface of the vehicle 502 and/or an interface of a secure verification system, such as an interface of the secure verification system 701a of FIG. 7.

In one or more embodiments or examples, the system 500 is configured to obtain item data indicative of an integrity of the item at start of the ride or during the ride and/or at end of the ride. In some examples, item data is for example image data (e.g., obtained by cameras 202a of FIG. 2). The item data can be seen as data indicative of an integrity of the item over time during the ride. For example, the item data can include sensor data such as image data from one or more cameras, temperature data from one or more heat cameras, and/or chemical data from one or more chemical sensors. In one or more embodiments or examples, the item data indicative of an integrity of the item is indicative of whether the item is broken or intact and/or whether the item has been tampered with. In one or more embodiments or examples, the system 500 is configured to determine an item status based on the item data and/or monitoring data. The system 500 can be configured to determine the item status at the vehicle 502 and/or at a remote AV system, such as remote AV system 701 of FIG. 7. The remote AV system can be configured to determine the item status based on item data and/or monitoring data obtained from the vehicle 502.

In one or more embodiments or examples, the system 500 is configured to provide the item status to a device, such as by providing the item data and/or the monitoring data. In one or more embodiments or examples, the system 500 is configured to provide the item status by providing the item status from the vehicle 502 to a ride service, such as a ride service on a remote AV system, e.g., remote AV system 701 of FIG. 7. In one or more embodiments or examples, the system 500 can be configured to provide the item status to a server for secure verification of the item status, e.g., a server included in the remote AV system. For example, the system 500 can be configured to provide the item status from the remote AV system (such as remote AV system 701 of FIG. 7) and/or the vehicle 502 (such as vehicle 702) to a user device, such as user device 530 of FIG. 5A, the user device 730, the loader 712, and/or the unloader 708 of FIG. 7. In some examples, the system 500 is configured to provide the item status by transmitting the item status, such as transmitting the item status from the secure verification system (such as secure verification system 701a of FIG. 7) and/or the vehicle 502 (such as vehicle 702) to the ride requestor, e.g., via a user device 530 of the ride requestor. The item status can for example be transmitted via an interface of the vehicle 502 and/or an interface of a secure verification system, such as an interface of the secure verification system 701a of FIG. 7.

In one or more embodiments or examples, the system 500 is configured to determine, based on the item data and/or monitoring data, an item status. In one or more embodiments or examples, the system 500 is configured to provide the item status to the device.

In one or more audio devices, embodiments or examples, the item includes one or more persons and/or one or more goods. In one or more embodiments or examples, the person is a loader of the item and/or an unloader of the item.

To control the operation can include to generate control data for a control system of an autonomous vehicle, such as vehicle 502. To control the operation can include to provide control data to a control system of an autonomous vehicle, such as vehicle 502. To control the operation can include to transmit control data to, e.g., a control system of an autonomous vehicle, such as vehicle 502, and/or an external system. To control the operation can include to control, based on control data, a control system of an autonomous vehicle and/or an external system, such as vehicle 502.

The first sensor data can be one or more of: radar sensor data, non-radar sensor data, camera sensor data, image sensor data, audio sensor, and LIDAR sensor data. The particular type of sensor data is not limiting. The first sensor data can be indicative of an environment around an autonomous vehicle. For example, the first sensor data can be indicative of an object, and/or a plurality of objects, in the environment around an autonomous vehicle.

The first sensor, such as first sensor 522 can be one or more sensors, such as a first onboard sensor. The first sensor 522 may be indicative of the autonomous vehicle. An autonomous vehicle may include one or more sensors that can be configured to monitor an environment where the autonomous vehicle operates, such as via the first sensor 522, through first sensor data. For example, the monitoring can provide first sensor indicative of what is happening in the environment around the autonomous vehicle, such as for determining trajectories of the autonomous vehicle. Sensors can include one or more of the sensors illustrated in FIG. 2. The first sensor 522 may be one or more of the sensors illustrated in FIG. 2.

The first sensor, such as first sensor 522 can be one or more of: a radar sensor, a camera sensor, a microphone, an infrared sensor, an image sensor, and a IN ONE OR MORE audio devices, In one or more example systems, the first sensor 522 can be selected from the group consisting of a radar sensor, a camera sensor, and a LIDAR sensor.

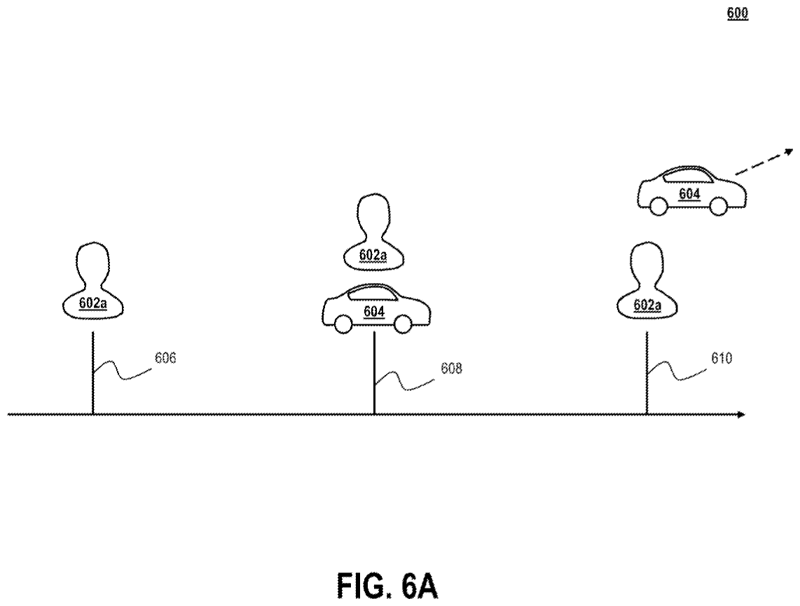

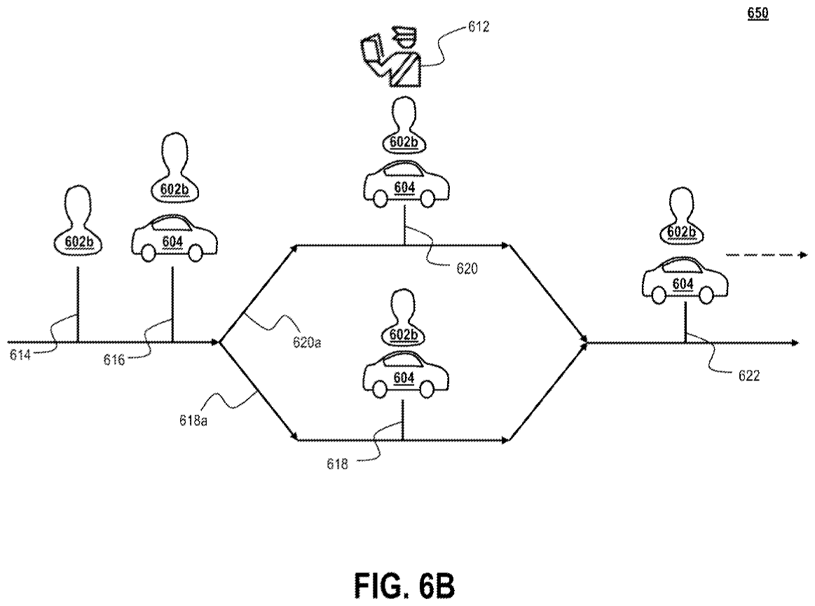

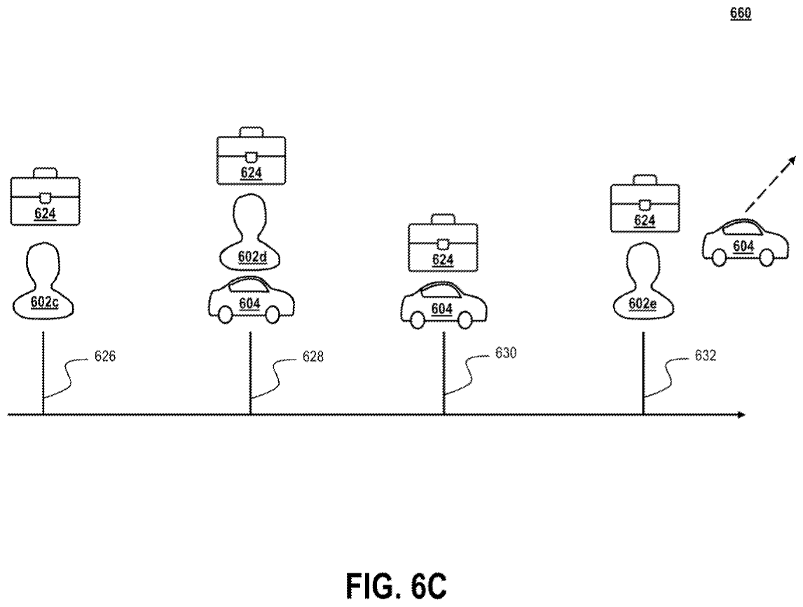

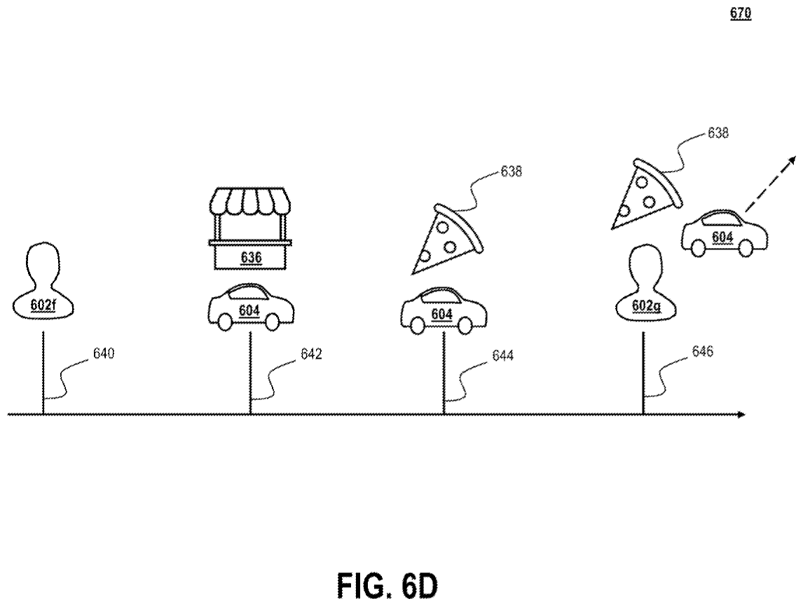

Referring now to FIGS. 6A-6D, diagrams 600, 650, 660, 670 depicting example scenarios are shown. The vehicle 604 includes an AV compute (such as the AV compute 202f of FIG. 2, the AV compute 400 of FIG. 4, the AV compute 504 of FIGS. 5A-5D and/or the AV compute 704 of FIG. 7.

In the examples of FIG. 6A-D the AV 604 is configured to obtain a ride request requesting a ride for an item to a destination. The AV 604 can be the same or similar as the vehicle 502 of FIGS. 5A-5D. The AV 604 is for example a robot-taxi. The AV 604 can be configured to obtain a ride request from a user device (e.g., a smartphone) indicative of a person. For example, the ride can be requested by a person from a user device via an application and/or web browser indicative of the AV 604.

In some examples, the AV 604 is configured to obtain a ride request requesting a ride for an item (e.g., for delivery and/or a transportation of an item from a starting location to a destination). In some examples, the item is a sensitive item. For example, the item can be fragile, perishable, and/or include confidential information. For example, the item can be sensitive to temperature and/or g-forces (e.g., roughness of ride). In some embodiments or examples, the AV 604 can be configured, such as by the requester (e.g., via the user device), to minimize g-forces during the ride (for example by driving more slowly and/or adjusting the suspension). The AV 604 can for example be configured to monitor the g-forces using a sensor (such as an accelerometer).

In the examples of FIGS. 6A-6D, the AV 604 is configured to obtain credential data indicative of one or more credentials indicative of the item. For example, obtaining credential data indicative of one or more credentials indicative of the item can include obtaining biometric data, identification data, sensor data, image data, and/or label data. In some examples, credential data can be seen as biometric data, identification data, sensor data, image data and/or label data. The AV 604 can be configured to obtain credential data indicative of one or more credentials indicative of the item inside the AV 604 and/or outside of the AV 604. For example, image data may comprise one or more images representing credentials associated with the item. Image data may for example comprise an image of an identification, such as an image of a passport, an image of a barcode, and/or an image of a QR code associated with the item.

In some examples, the AV 604 is configured to obtain one or more first credentials indicative of the item before and/or at the start of the ride. In other words, a first credential can be seen as a credential indicative of the item before and/or at the start of the ride. In some examples, credential data indicative of a first credential can be seen as first credential data. In some examples, the AV 604 is configured to obtain one or more second credentials indicative of the item after and/or at the end of the ride. In other words, a second credential can be seen as a credential indicative of the item after and/or at the end of the ride. In some examples, credential data indicative of a second credential can be seen as second credential data. In some examples, the AV 604 can be configured to obtain credential data indicative the one or more credentials using one or more internal sensors and/or dedicated secure verification devices and/or systems. In some examples, the internal sensors include cameras, LiDAR sensors, 3D scanners and/or optical scanners.

In some examples, the credential data (such as the personal credential data) can be data indicative of the health of an item. For example, the AV 604 can be configured to obtain credential data indicative of the health of an item (such as health of passenger 602a, 602b). The first credential data indicative of the health of the item is for example indicative of one or more health credentials (e.g., covid passport). The credential data indicative of the health of the item can for example include temperature data. In some examples, the AV 604 can be configured to obtain the temperature data of an item using a thermal camera. In some examples, when the temperature data indicates the item has a temperature above a threshold temperature (e.g., a threshold temperature for a fever) the ride request may be rejected, or a different AV may be assigned in lieu of the AV 604. In some examples, the AV 604 is configured to prevent access of an item (such as passenger 602a) to a destination based on temperature data.

Biometric data can for example be obtained via one or more internal and/or external sensors. For example, the face recognition data can be obtained from one or more internal and/or external cameras (such as cameras 202a of FIG. 2). In some examples, the AV 604 is configured to obtain credential data, such as biometric data (e.g., fingerprint data), indicative of the item (such as passenger 602a). In some examples, the AV 604 is configured to obtain a ride request including fingerprint data indicative of the item (such as passenger 602a). In some examples, the credential data includes credential data indicative of the identity of the item (such as the identity of passenger 602a).

In the examples of FIG. 6A-6D, the AV 604 is configured to verify 608 the one or more credentials indicative of the item. In some examples, verifying the one or more credentials includes comparing credential data obtained with the ride request from the ride requester, against credential data obtained before and/or at the start of the ride. In some examples, the AV 604 is configured to determine whether this credential data matches. In some examples, the AV 604 is configured such that when the credential data matches, then the credential data is successfully verified. In other words, verifying the credential data at the start of the ride can include comparing the one or more first credentials with a credential obtained with a ride request. In other words, verifying the credential data can include determining that the one or more credentials matches. In some examples, the AV 604 can be configured such that the identity of a person is considered verified by the AV when the identity matches the identity of the person for whom the ride was requested.

In some examples, verifying the first credential data includes authenticating a person. In other words, the AV 604 can be configured to authenticate a person (such as passenger 602a) based on the credential data. In some examples, the AV 604 can be configured to authenticate the person based on the credential data indicative of the person. In some examples, access to the AV 604 can be restricted until the person has been authenticated. In other words, once the person (such as passenger 602a) has been authenticated, the person can be authorized to enter the AV 604.

In the examples of FIG. 6A-6D, in response to successful verification of the one or more credentials indicative of the item, the AV 604 is configured to generate route data indicative of a route for the ride by an autonomous vehicle, based on the ride request. In some examples, the AV 604 is configured to generate the route data using the AV compute (such as the AV compute 504 of FIG. 5). In some examples, the AV 604 is configured to generate the route data using a planning system (such as planning system 404 of FIG. 4 and/or planning system 504a of FIG. 5). In some examples, the route data generated by the planning system (such as the planning system 404 of FIG. 4 and/or planning system 504a of FIGS. 5B-C) can be provided to the control system (such as control system 408 of FIG. 4 and/or control system 504b of FIGS. 5C-D). In some examples, the AV 604 is configured to generate and transmit a control signal for operation of the AV 604 (as shown in FIG. 5D). In some examples, the route data includes data indicative of a route from the present location of the AV 604 to the destination (such as a final destination). For example, the credential data indicative of the credential can be indicative of the final destination. In some examples, the AV 604 can be configured to offer to reroute a passenger 602a (such as to a final destination) based on the credential data. For example, the AV can be configured to provide passenger 602a with an offer to update the final destination of the ride based on the one or more credentials. In some examples, the AV 604 is configured to provide the offer to update the final destination to a user device indicative of the user (such as passenger 602a). In some examples, the AV 604 is configured to generate route data upon obtaining a ride request. In some examples, the AV 604 can be configured such that credential data is not needed to generate a route. In some examples, the AV 604 is configured such that when the first credential data is successfully verified, the AV 604 initiates generation of route data. In some examples, triggering of the start of the ride includes transmitting a control signal (such as transmitting control signal 520 of FIG. 5D) to a DBW system (such as the DBW system 506 of FIG. 5D) for controlling of the AV 604.

FIG. 6A shows a first example scenario 600 where the disclosed technique is applied. In the example of FIG. 6A, the AV 604 is configured to obtain a ride request requesting a ride for an item to a destination. Alternatively or additionally, a remote AV system (such as remote AV system 701 of FIG. 7) is configured to obtain the ride request and to transmit, to the AV 604, route data to a starting location where the item is located. In the example of FIG. 6A, the item is a passenger 602a and the destination is a concert venue. In other words, the AV 604 is configured to obtain a ride request requesting 606 a ride to a concert venue for the passenger 602a. For example, the passenger 602a requests a ride to a concert venue for which the passenger 602a has a concert ticket. In other words, the passenger 602a can be the requestor of the ride. In some examples, the AV 604 is configured to, after receiving the ride request, drive to the location of passenger 602a (e.g., to pick up the passenger 602a). In the example of FIG. 6A, the AV 604 is configured to obtain credential data indicative of one or more credentials indicative of the item. In the example of FIG. 6A, the one or more credentials includes the concert ticket indicative of passenger 602a. In the example of FIG. 6A, the credential data is indicative of the concert ticket indicative of passenger 602a. For example, the credential data indicative of the concert ticket indicative of passenger 602a includes label data. In other words, the label data is indicative of the concert ticket indicative of passenger 602a. The label data can be indicative of a scannable feature (such as a barcode and/or a QR code). The AV 604 can be configured to obtain label data via a scanning device (such as an optical scanner). The ride request can include label data indicative of the concert ticket indicative of passenger 602a. In some examples, the AV 604 is configured to obtain fingerprint data indicative of the fingerprint of passenger 602a using a fingerprint scanner (e.g., a fingerprint scanner located on the door handle of AV 602).

In the example of FIG. 6A, the AV 604 is configured to verify 608 the one or more credentials indicative of the item. In some examples, the AV 604 is configured to verify 608 the concert ticket indicative of passenger 602a. In the example of FIG. 6A, verifying 608 the one or more credentials includes verifying personal credentials indicative of a person. In the example of FIG. 6A, the label data indicative of the concert ticket indicative of passenger 602a can be seen as the personal credential data. The AV 604 can be configured to provide an offer to passenger 602a to verify the concert ticket indicative of passenger 602a. In some examples, the AV 604 can be configured to verify 608 the label data using the AV compute. For example, the AV 604 can store (such as using database 410 of FIG. 4) label data indicative of valid concert tickets. The AV 604 can be configured to verify the concert ticket of passenger 602a by comparing the label data indicative of the concert ticket indicative of passenger 602a to label data (for example stored on database 410 of FIG. 4) indicative of valid concert tickets. In some examples, when the label data indicative of the concert ticket indicative of passenger 602a is the same as the label data indicative of a valid concert ticket stored by the AV 604, then the concert ticket indicative of passenger 602a is successfully verified. In other words, when the label data indicative of the concert ticket indicative of passenger 602a is already stored (for example stored on database 410 of FIG. 4) by the AV 604, then the concert ticket indicative of passenger 602a is successfully verified. In some examples, the vehicle 604 is configured to verify the concert ticket of passenger 602a, by comparing the barcode of the concert ticket of the passenger 602a with the barcode of a valid ticket. In some examples, the AV 604 can be configured to verify 608 the concert ticket using an external server (such as a server indicative of concert venue verification service). In some examples, the AV 604 is configured to verify 608 the concert ticket by providing the label data from the AV 604 to a third-party capable of independently verifying the concert ticket (such as a server indicative of concert venue verification service). In some examples, a verification service indicative of the concert venue includes an external server with which the AV 604 can be configured to communicate (e.g., provide data to and/or obtain data from). In some examples, the AV 604 can be configured to provide the label data indicative of the concert ticket to a server indicative of concert venue (e.g., a server indicative of the concert venue verification service). In one or more embodiments or examples, the AV 604 can be configured to communicate with the external server via a remote AV system (such as remote AV system 701 of FIG. 7). Alternatively or additionally, the remote AV system is configured to verify the one or more credentials and to transmit an acknowledgement of the verification to the AV 604. The verification service indicative of the concert venue can for example include one or more databases including label data indicative of valid concert tickets. The label data provided to the concert venue verification service by the AV 604 can then be verified 608 using the concert venue verification service. In some examples, when the label data indicative of the concert ticket indicative of passenger 602a matches label data indicative of a valid concert ticket stored on the database of the concert venue verification service, the concert ticket indicative of passenger 602a is successfully verified. In some examples, the AV 604 and/or the user device are configured to obtain biometric data indicative of the fingerprint of passenger 602a. For example, the AV 604 is configured to obtain a ride request including biometric data (e.g., data indicative of a fingerprint) indicative of the passenger 602a. In some examples, the AV 604 is configured to obtain biometric data indicative of passenger 602a (e.g., via a fingerprint scanner). In some examples, when the AV 604 obtains biometric data directly from passenger 602a (e.g., when passenger 602a touches a fingerprint scanner of AV 604) matching the biometric data included in the ride request indicative of passenger 602a, the credential data is successfully verified. In some examples, the one or more credentials includes an identifier indicative of a person. The identifier can for example be a barcode and/or a QR code. The label data can include the identifier. For example, the label data can be an image including the identifier. In some examples, verifying the one or more first credentials includes verifying one or more of: biometric data, identification data, sensor data, image data and label data. For example, the fingerprint of passenger 602a can be seen as biometric data. The AV 604 can be configured to verify the obtained fingerprint of passenger 602a by communicating with a database storing fingerprint data indicative of people (such as the passenger 602a). In some examples, the AV 604 can be configured to obtain identification data from a user device (such as the user device indicative of passenger 602a). For example, the AV 604 can be configured to verify passenger 602a by obtaining identification data (such as via Bluetooth and/or NFC) from a user device indicative of passenger 602a. For example, a communication device of AV 604 (such as communication device 202e of vehicle 200) can be configured to communicate using Bluetooth and/or NFC with the user device indicative of passenger 602a.

In the example of FIG. 6A, in response to successful verification of the one or more credentials indicative of the item, the AV 604 is configured to generate, route data indicative of a route indicative of the ride by an autonomous vehicle, based on the ride request. In some examples, generating the route data includes generating, based on the first credential data, the route data. In other words, the AV 604 can be configured to generate route data based on the label data obtained from the concert ticket. For example, in response to successful verification of the concert ticket indicative of passenger 602a, the AV 604 is configured to generate a route to the concert venue. Alternatively or additionally, the AV 604 is configured to obtain route data from a remote AV system (such as remote AV system 701 in FIG. 7) configured to generate route data indicative of a route indicative of the ride by an autonomous vehicle, based on the ride request. In other words, the label data indicative of the concert ticket includes information indicative of the location of the concert venue. In some examples, the AV 604 is configured to generate route data indicative of a route including the location of the concert venue. In some examples, generating the route data includes updating, based on the first credential data, a final destination of the ride service. In other words, the AV 604 is configured to generate the route data by updating, based on the label data indicative of the concert ticket indicative of the passenger 602a, a final destination of the ride service. In some examples, the precise location where the AV 604 drops-off passenger 602a can be based on the concert ticket indicative of passenger 602a for which the AV 604 scanned the barcode and/or QR code. In some examples, the destination includes a plurality of entrances and/or drop-off locations (e.g., multiple airport terminals of one airport, multiple entrances to one concert venue, etc.). Any of the one or more locations at a destination can be seen as the final destination. For example, a VIP entrance of the concert venue can be seen as a final destination. In other words, the final destination can be seen as a more specific and/or precise location than the destination. For example, the concert ticket indicative of passenger 602a can be a VIP concert ticket. In some examples, the concert ticket indicative of passenger 602a can be a VIP concert ticket indicative of a VIP entrance of the concert venue. In some examples, the route data is generated, based on the label data, such that the AV 604 delivers the passenger 602a at the VIP entrance (e.g., the ride terminates at the VIP entrance). In some examples, upon successful verification of the credential data, a final destination (such as the VIP entrance) is provided to the AV 604. In some examples, the final destination (e.g., the location of the VIP entrance) is provided to the AV 604 by the concert venue verification service and/or the remote AV system.

In some examples, the AV 604 is configured to trigger, based on the route data, a start of the ride towards the destination upon successful verification of the credential data. In some examples, triggering of the start of the ride includes generating control data for controlling of the AV 604. In some examples, the AV 604 is configured to deliver 610 the passenger 602a to the final destination. In the example of FIG. 6A, the AV 604 deliver 610 the passenger 602a to the VIP entrance of the concert venue. In some examples, the AV 604 is configured to drive to a different location after dropping off passenger 602a (e.g., drive to a new starting location indicative of a new (such as next) ride request).

FIG. 6B shows a second example scenario 650 where the disclosed technique is applied. In the example of FIG. 6B, the AV 604 is configured to obtain a ride request requesting a ride for an item from a starting location to a destination. In other words, the AV 604 is configured to obtain a ride request requesting a ride to a destination for which a border crossing is required. In some examples, the AV 604 is configured to obtain a ride request 614 from passenger 602b. The item can be seen as a passenger 602b. The destination can be seen as a location in a different country and/or state (e.g., at some point during the ride a border crossing can be required). In some examples, the AV 604 can be configured such that passenger 602b can request a ride across a border. In some examples, the border can be the border of a province, county, state, State (e.g., a country) and/or the like. In some examples, the border can be a border separating a public area from a private area (such as a gated community).

In the example of FIG. 6B, the AV 604 is configured to obtain credential data indicative of one or more credentials indicative of the item. In the example of FIG. 6B, in response to receiving the ride request, the AV 604 drives to the location of passenger 602b, such as a starting location of a ride. In some examples, government documents (such as a passport and/or driver's license) can be seen as credentials. In some examples, government documents include identification data indicative of the government document indicative of the passenger 602b. In the example of FIG. 6A, the government document indicative of the passenger 602b is a passport. In some examples, AV 604 can be configured to obtain the identification data indicative of the passport indicative of the passenger 602b using a camera and/or a scanner. In some examples, the AV 604 can be configured to obtain identification data indicative of a passport using cameras (e.g., cameras 202a of FIG. 2). In the example of FIG. 68, the AV 604 can be configured to obtain identification data and/or biometric data. In some examples, biometric data (e.g., iris scanner data, fingerprint data, face recognition data, weight data and/or body shape data) indicative of the passenger 602b can be seen as credential data. For example, the AV 604 can be configured to obtain 3D scanner data indicative of the face of passenger 602b using one or more cameras (such as cameras 202a of FIG. 2).

In the example of FIG. 6B, the AV 604 is configured to verify 616 the one or more credentials indicative of the item. In some examples, the AV 604 is configured to verify 616 the passport indicative of the passenger 602b. In the example of FIG. 6B, verifying 616 the one or more credentials includes verifying personal credential data indicative of a person (such as passenger 602b). In the example of FIG. 6A, identification data indicative of the passport indicative of the passenger 602b can be seen as personal credential data. In some examples, the identification data indicative of the passport indicative of passenger 602b can be seen as the first credential data. In some examples, verifying the one or more first credentials includes, authenticating a person. In other words, the AV 604 can be configured to authenticate the passenger 602b using the passport indicative of passenger 602b. In some examples, verifying the one or more first credentials includes verifying one or more of: biometric data, identification data, sensor data, image data and label data. In some examples, the AV 604 can be configured to obtain identification data from a passport indicative of the passenger 602b. In one or more embodiments or examples, the AV 604 can be configured to communicate with an external server via a remote AV system (such as remote AV system 701 of FIG. 7). Alternatively or additionally, the remote AV system is configured to verify 616 the one or more credentials and to transmit an acknowledgement of the verification to the AV 604. In other words, the AV 604 can be configured to verify the passport indicative of the passenger 602b, for example by communicating with a secure verification service (such as a border patrol verification service). For example, the AV 604 can be configured to communicate with the secure verification service using the communication device 202e of FIG. 2. In the example of FIG. 6A, the AV 604 can be configured to provide the identification data indicative of the passport indicative of passenger 602b to a passport database indicative of a border patrol verification service. In some examples, the border patrol verification service can verify 616 whether the credentials indicative of the passenger 602b are valid or not. In some examples, the passport database stores identification data indicative of valid passports. In some examples, when the identification data indicative of the passport indicative of passenger 602b matches identification data indicative of a valid passport stored on the passport database of the secure verification service, the passport indicative of passenger 602b is successfully verified.

In the example of FIG. 6B, in response to successful verification of the one or more credentials indicative of the item, the AV 604 is configured to generate, route data indicative of a route indicative of the ride by an autonomous vehicle, based on the ride request. In other words, the AV 604 can be configured to generate route data indicative of a route across a border. In some examples, generating the route data includes generating the route data based on the first credential data. In other words, the AV 604 is configured to generate route data indicative of a route based on the identification data indicative of the passport indicative of passenger 602b. In the example of FIG. 6B, the AV 604 can be configured to generate route data indicative of a manual verification route 620a and/or route data indicative of a fast lane route 618a (such as a route without manual verification). In one or more embodiments or examples, the AV 604 is configured to generate route data including manual verification in response to an unsuccessful verification of the credentials. In one or more embodiments or examples, the AV 604 is configured to generate route data including the fast lane route in response to a successful verification of the credentials. In other words, when the credentials are successfully verified, the generated route includes automatic verification of identity, and the AV 604 can drive via the fast lane route. The manual verification route 620a can include manual credential verification 620 of the credentials, such as manual verification of the identification data indicative of the passport indicative of passenger 602b. In some examples, a route can include the manual verification route 620a and/or the fast lane route 618a. In some examples, routes including the manual verification route 620a or the fast lane route 618a include the same start location and/or destination (such as final destination). The manual credential verification of the manual verification route 620a can for example be carried out by an official 612 (such as a border patrol agent). In some examples, the manual credential verification 620 of the manual credential verification route 620a can be seen as an intermediate destination (e.g., a destination after the start of the ride and before the end of the ride). In some examples, the fast lane route 618a includes crossing a border 618 without manual credential verification (e.g., without an intermediate destination). In some examples, the selection of the passenger 602b for manual credential verification 620 is random, e.g., for randomized manual verification. In some examples, this random selection process can be carried out by the AV compute of AV 604 and/or by an external server (such as a server indicative of the border patrol verification service). In some examples, the majority of vehicles (such as vehicle 604) travel along the fast lane route 618a. In some examples, the AV 604 is configured to generate route data based on whether the passenger 602b is selected for manual credential verification 602b or not. Advantageously, the manual credentials verification 620 can ensure the validity of the verification of the credential data such as by uncovering fraud (e.g., counterfeit credentials). In some examples, the AV 604 is configured to proceed 622 from the manual verification route 620a and/or the fast lane route 618a to a final destination.

FIG. 6C shows a third example scenario 660 where the disclosed technique is applied. In the example of FIG. 6C, the AV 604 is configured to obtain a ride request requesting a ride for an item to a destination. In other words, the AV 604 is configured to obtain a ride request 626 from a requester 602c. In the example of FIG. 6C, the delivery location is the location of unloader 602e. In the example of FIG. 6C, the item is a confidential document 624 (e.g., police evidence, court documents, bank statements, etc.)

In the example of FIG. 6C, the AV 604 is configured to obtain credential data indicative of one or more credentials indicative of the item. In the example of FIG. 6C, the AV 604 drives to the location of loader 602d. In the example of FIG. 6C, the AV 604 can be configured to obtain credential data indicative of credentials indicative of the confidential document 624. In some examples, the credential data indicative of the confidential document 624 can be seen as goods credential data. For example, the loader 602d can be seen as being indicative of the confidential document 624. In some examples, the AV 604 is configured to obtain credential data indicative of credentials of the loader 602d. For example, the AV 604 is configured to obtain fingerprint data from the loader 602d using a fingerprint scanner. In some examples, the confidential document 624 includes an identifier. For example, the identifier can be a barcode and/or a QR code. In some examples, the AV 604 is configured to obtain label data from the barcode and/or QR using an optical scanner. In some examples, the loader 602d has an identification device (e.g., RSA fob, a SIM card, an authenticator app, and/or a phone etc.). In some examples, the AV 604 is configured to obtain identification data indicative of the identification device indicative of the loader 602d. In some examples, a scanner and/or sensor of the AV 604 is configured to obtain identification data from the identification device using RFID, Bluetooth and/or NFC.

In the example of FIG. 6C, the AV 604 is configured to verify the one or more credentials indicative of the item. In other words, the AV 604 is configured to verify the credentials of the loader 602d and/or the credentials of the unloader 602e. In the example of FIG. 6C, verifying 628 the one or more credentials includes verifying one or more of: personal credential data indicative of a person and/or goods credential data indicative of one or more goods. In some examples, the AV 604 can be configured to verify the credentials indicative of the credential data indicative of the confidential documents 624 using the AV compute. In some examples, the AV 604 can be configured to verify the credentials indicative of the credential data indicative of the confidential documents 624 via an external server (such as a server indicative of secure verification services). In some examples, the credential data is provided to a third-party who can independently verify the credential data. In some examples, the identification data is verifiable with third-party secure verification service integrations (such as a two-factor authentication system). In some examples, verifying the credential data includes verifying one or more first credentials indicative of one or more credentials indicative of the item before and/or at a start of a ride. In the example of FIG. 6C, the first credential data can be seen as the credential data indicative of the loading of confidential documents 624 to the AV 604. In other words, the first credential data can be seen as the credential data indicative of the loader 602d (e.g., identification data indicative of the RSA fob indicative of the loader 602d). In some examples, the AV 604 is configured to obtain second credential data indicative of a second credential indicative of the item at and/or after an end of the ride. In the example of FIG. 6C, the second credential data can for example be seen as the credential data indicative of the unloading of confidential documents 624 from the AV 604. For example, the second credential data can be seen as the credential data indicative of the unloader 602e (e.g., identification data indicative of an RSA fob indicative of the loader 602d). In some examples, verifying 628 the one or more first credentials includes, authenticating a person and/or verifying the integrity and/or origin of a good. In some examples, the AV 604 can be configured to authenticate the loader 602d based on the biometric data (such as fingerprint data). In some examples, the AV 604 can be configured to verify the integrity and/or origin of the credential documents 624 based on the credential data. In some examples, the AV 604 is configured to verify 632 the second credential. In some examples, verifying the identity of the unloader 602e includes verifying the second data (e.g., as the unloader 602e takes custody of the confidential documents 624). As an example, the AV 604 can be configured to verify the biometric data indicative of unloader 602e. For example, the AV 604 can be configured to verify the identity of the unloader 602e prior to granting access to the AV 604. In other words, access to the AV 604 is restricted until the loader 602d is verified. In some examples, the AV 604 is configured to determine, based on the verification of the second credential, an authentication status. For example, the AV 604 can be configured to identify whether or not the unloader 602e is authenticated to unload the confidential documents 624 from the AV 604.

In the example of FIG. 6C, in response to successful verification of the one or more credentials indicative of the item, the AV 604 is configured to generate, route data indicative of a route indicative of the ride by an autonomous vehicle, based on the ride request. In some examples, once the first credential data indicative of the credential document 624 has been verified 628, the planning system 404 of FIG. 4 can generate route data indicative of a route indicative of the ride. In the example of FIG. 6C, the confidential documents are transported 630 by AV 604 to the location of the unloader 602e. In one or more embodiments or examples, the AV 604 is configured to obtain monitoring data indicative of a monitoring of the item during the ride and/or obtain item data indicative of an integrity of the item at start of the ride or during the ride and/or at end of the ride. For example, the confidential documents 624 can be monitored by RVA personnel at a start of the ride, during the ride, and/or at the end of the ride, based on the monitoring data and/or the item data. The confidential documents 624 can for example be monitored throughout the entire ride using cameras of the AV 604 (such as cameras 202a of FIG. 2). Therefore, the chain of custody can remain unbroken throughout the ride. In other words, the AV 604 can be seen as a secure link in a chain of custody. In other words, as the confidential documents 624 can be monitored throughout the ride, it can be determined whether unauthorized access has been gained to the confidential documents during the ride and/or determined whether the integrity of the confidential documents has been altered.

The AV 604 is configured to obtain the credential data indicative of the credentials of the unloader 602e. In some examples, the credential data of the unloader 602e can be seen as second credential data. For example, the AV 604 is configured to obtain fingerprint data from the unloader 602e using a fingerprint scanner. In some examples, the unloader 602e has an identification device (e.g., RSA fob, a SIM card, an authenticator app, and/or a phone etc.). In some examples, the AV 604 is configured to obtain identification data indicative of the identification device indicative of the unloader 602e. In some examples, a scanner and/or sensor of the AV 604 is configured to obtain identification data from the identification device using RFID, Bluetooth and/or NFC.

After the credentials of the unloader 602e have been successfully verified, the unloader 602e can then collect the confidential documents from the AV 604. The AV 604 can be configured to continue onto another ride request after the item has been successfully delivered to the verified unloader 602e.

In some examples, the AV 604 is configured to, upon successful verification of the second credential, generate, based on the second credentials, control data for controlling the autonomous vehicle. In some examples, the AV 604 is configured to restrict access to unauthenticated users. For example, the AV 604 is locked until the AV 604 obtains biometric data indicative of an unloader 602e. For example, the AV 604 is locked until the AV 604 obtains fingerprint data from the unloader 602e. In some examples, when the unloader 602e touches a fingerprint scanner of the AV 604, the AV 604 is configured to provide access for the unloader 602e (e.g., when the fingerprint data is successfully verified). In some examples, the AV 604 is configured such that the control data generated based on the second credential data is indicative of an end of the ride. For example, the AV 604 can be configured to generate ending instructions indicative of an end of the ride.

FIG. 6D shows a fourth example scenario 670 where the disclosed technique is applied. In the example of FIG. 6D, the AV 604 is configured to obtain a ride request requesting a ride for an item to a destination. In other words, the AV 604 can be configured to obtain a ride request 640 from a requester 602f (e.g., law enforcement office employee). In the example of FIG. 6D, the item is a food package 638 (e.g., a container with food inside). In the example of FIG. 6D, the delivery location is the location of unloader 602g. The example of FIG. 6D can be seen as a food delivery from a credentialed sender to a customer in need of a verification of the sender.

In the example of FIG. 6D, the AV 604 is configured to obtain credential data indicative of one or more credentials indicative of the item. In the example of FIG. 6D, the AV 604 drives to the location of whitelisted restaurant 636. In the example of FIG. 6D, the whitelisted restaurant 636 can be seen as an entity (e.g., a firm, an organization and/or a company). In some examples, the credential data indicative of the whitelisted restaurant 636 can be seen as entity credential data. In some examples, the credential data of the whitelisted restaurant 636 applies to all people (e.g., loaders) who can load the AV 604 on behalf of the whitelisted restaurant 636. In other words, all employees of the whitelisted restaurant 636 can have an employee keycard indicative of the whitelisted restaurant 636 from which the AV 604 can be configured to obtain credential data (e.g., by scanning using an optical scanner). In the example of FIG. 6D, the AV 604 can be configured to obtain credential data indicative of credentials indicative of the food package 638. For example, the whitelisted restaurant 636 can be seen as being indicative of the food package 638. In one or more embodiments or examples, the AV 604 is configured to verify the credentials of the whitelisted restaurant 636, such as sender of the item, before accepting the ride request indicative of the food delivery. In some examples, the AV 604 is configured to obtain credential data indicative of credentials of the whitelisted restaurant 636. For example, the AV 604 is configured to obtain fingerprint data from a loader indicative of the whitelisted restaurant 636 using a fingerprint scanner. In some examples, the food package 638 includes an identifier. For example, the identifier can be a barcode and/or a QR code. In some examples, the AV 604 is configured to obtain label data from the barcode and/or QR code using an optical scanner. In some examples, the person loading the AV 604 with the food package 638 from the whitelisted restaurant 636 has an identification device (e.g., RSA fob, a SIM card, an authenticator app, and/or a phone etc.). In some examples, the AV 604 is configured to obtain identification data indicative of the identification device indicative of the whitelisted restaurant 636. In some examples, a scanner and/or sensor of the AV 604 is configured to obtain identification data from the identification device using RFID, Bluetooth and/or NFC.

In the example of FIG. 6D, the AV 604 is configured to verify 642 the one or more credentials indicative of the item. In other words, the AV 604 is configured to verify the credentials of the loader indicative of the whitelisted restaurant 636 (such as an employee of the whitelisted restaurant 636) and/or the credentials of the unloader 602g. In some examples, the AV 604 can be configured to obtain monitoring data indicative of monitoring an item during the ride. For example, temperature data of the food package 638 can be monitored throughout the ride using thermal sensors. The temperature data can then be used to determine the status of the food package (e.g., such as the temperature). In some examples, the AV 604 can be configured to obtain data indicative of the integrity of an item. For example, the food package 638 includes fragile objects (e.g., breadsticks). In some examples, the AV 604 is configured to determine, based on the item data and/or monitoring data, an item status (e.g., the breadsticks are intact or broken). In some examples, the AV 604 can be configured to provide the item status to the unloader 602g, such as via the interface of the user device (such as user device 530 of FIG. 5A) of the unloader 602g.

In the example of FIG. 6D, in response to successful verification of the one or more credentials indicative of the item, the AV 604 is configured to generate, route data indicative of a route indicative of the ride by an autonomous vehicle, based on the ride request. In the example of FIG. 6D, the AV 604 is configured such that, in response to the successful verification of the credentials indicative of the credential data of the loader indicative of the whitelisted restaurant 636, the AV 604 generates route data. In some examples, the AV 604 is configured to generate route data using the planning system 404 of FIG. 4 and/or planning system 504a of FIG. 5. In the example of FIG. 6D, the AV 604 transports 644 the food package 638 to the unloader 602g. In some examples, the unloader 602g can be the same person as the requestor 602f. During the ride, the food package 638 can be monitored by RVA personnel. The food package 638 can for example be monitored throughout the entire ride using image data cameras 202a of FIG. 2. In some examples, the AV 604 is configured such that the ride is uninterrupted.

The AV 604 is configured to verify 646 the credential data of the unloader 602g. In some examples, the credential data of the unloader 602g can be seen as the second credential data. For example, the AV 604 is configured to obtain fingerprint data from the unloader 602g using a fingerprint scanner. In some examples, the food package 638 includes an identifier. For example, the identifier can be a barcode and/or a QR code. In some examples, the AV 604 is configured to obtain label data from the barcode and/or QR using an optical scanner. In some examples, the unloader 602g has an identification device (e.g., RSA fob, a SIM card, an authenticator app, and/or a phone). In some examples, the AV 604 is configured to obtain identification data indicative of the identification device indicative of the unloader 602g. In some examples, a scanner and/or sensor of the AV 604 is configured to obtain identification data from the identification device using RFID, Bluetooth and/or NFC. In some examples, the AV 604 is configured such that the control data generated based on the second credential data is indicative of an end of the ride. For example, the AV 604 can be configured to generate ending instructions indicative of an end of the ride.

Referring now to FIG. 7, a diagram of an example system 700 is disclosed. In one or more embodiments or examples, the system 700 is connected with and/or incorporated in a vehicle, such as vehicle 702 (e.g., an autonomous vehicle that is the same as, or similar to, vehicle 102 of FIG. 1, vehicle 200 of FIG. 2, and vehicle 502 of FIG. 5). In one or more embodiments or examples, system 700 is in communication with and/or a part of an AV (e.g., such as Autonomous System 202 illustrated in FIG. 2, device 300 of FIG. 3, and/or System 500 of FIG. 5), an AV system, an AV compute, such as AV compute 704 (such as AV compute 202f of FIG. 2, AV compute 400 of FIG. 4, and/or AV compute 504 of FIG. 5), a remote AV system 701 (such as remote AV system 114), a fleet management system (such as fleet management system 116 of FIG. 1), and a V2I system (such as V2I system 118 of FIG. 1). In one or more embodiments or examples, system 700 is for operating an autonomous vehicle. Different operations and/or steps of the method and/or the system may be performed at different devices, such as at the remote AV system 701, at the vehicle 702, at the user device 730, at the loader 712, and/or at the unloader 708. In one or more embodiments or examples, the remote AV system 701 may be seen as being remote from the vehicle 702, such as remote from the AV compute 704. In one or more embodiments or examples, the remote AV system 701 is configured to operate on one or more servers. In one or more embodiments or examples, the remote AV system 701 is configured to perform the operations and/or steps of the method and/or the system as disclosed herein.

In some examples, the vehicle 702 includes the AV compute 704. In some examples, user device 730 includes some and/or all of the features discussed with respect to user device 530 of FIG. 5A. For example, the user device 730 is indicative of a ride requestor (such as requestor 602c of FIG. 6C and/or requestor 602f of FIG. 6D). In some examples, the person is indicative of an item 706. In some examples, the item 706 includes one or more people and/or one or more goods.

In some examples, a loader 712 is a person and/or device which carries out the transition of moving the item 706 from outside of vehicle 702 to inside of vehicle 702. In some examples, the loader 712 is indicative of first credential data indicative of one or more first credentials. In some examples, a requestor indicative of a user device 730 is the same as the loader 712. In some examples, an unloader 708 is a person and/or device which carries out the transition of moving the item 706 from inside of vehicle 702 to outside of vehicle 702. In some examples, the loader 712 is indicative of second credential data indicative of one or more second credentials. In some examples, the loader 712 and the unloader 708 are different. In some examples, the loader 712 and the unloader 708 are the same.

In one or more embodiments or examples, the system 700 includes a remote AV system 701 (such as remote AV system 114 of FIG. 1). In some examples, remote AV system 701 is the same as the remote AV system 114 of FIG. 1. In the example of FIG. 7, remote AV system 701 includes a secure verification system 701a and/or a credential manager system 710. In some examples, the credential manager system 710 includes a person identification system 710a, a goods identification system 710b, and/or an entity verification system 710c. These systems will further be discussed below. In some examples, the arrows shown in FIG. 7 indicate communication and/or transfer of data and/or information.

In some examples, a requestor can request a ride for an item 706 from a starting location to a destination (e.g., via secure verification system 701a). In some examples, the system 700 is configured such that the vehicle 702 obtains from the user device 730, the ride request requesting a ride for an item 706 from a starting location to a destination. For example, the system 700 is configured to obtain the ride request from the user device 730 using Bluetooth, NFC and/or RFID. For example, a requestor can request a ride to a concert venue via a user device 730 (e.g., a smartphone). In some examples, the requestor requests a verified ride and/or delivery with specific authentication and/or verification. In some examples, the remote AV system 701 is configured to obtain from a requestor, via user device 730, a ride request requesting a ride to a concert venue. In some examples, the remote AV system 701 is configured to obtain, via user device 730, a ride request for a verified ride and/or delivery with specific authentication and/or verification.

In one or more embodiments or examples, the system 700 is configured such that vehicle 702 obtains credential data indicative of one or more credentials indicative of the item 706. For example, when the credential is a concert ticket, the system 700 is configured such that the vehicle 702 obtains credential data (e.g., label data) indicative of the concert ticket using an optical scanner (e.g., by scanning the barcode on the concert ticket). In some examples, the ride request includes credential data indicative of one or more credentials indicative of the item 706. In other words, the system 700 is configured such that the vehicle 702 obtains credential data indicative of one or more credentials indicative of the item 706 from the user device 730. In some examples, the system 700 provides the ride request including the credential data to the secure verification system 701a. The secure verification system 701a can then provide the ride request including the credential data to the vehicle 702. In some examples, the secure verification system 701a requests any necessary verification to start the ride. In other words, the secure verification system 701a is configured to request from the credential manager system 710 any necessary verification to start the ride. In one or more embodiments or examples, the secure verification system 701a requests any necessary verification to start the ride from the loader 712, the vehicle 702 and/or the item 706 (such as via an interface indicative of the secure verification system 701a). Necessary verification to start the ride can be seen as verification required for the ride to begin (e.g., concert ticket verification).

In one or more embodiments or examples, the system 700 is configured to verify the one or more credentials by verifying one or more first credentials indicative of the item 706 before and/or at a start of the ride. In some examples, the system 700 is configured to verify the one or more credentials by verifying one or more second credentials indicative of the item 706 after and/or at an end of the ride. In one or more embodiments or examples, the credential manager system 710 authenticates and/or verifies the loader 712 and/or item 706 entering the vehicle 702. For example, the credential manager system 710 is configured to authenticate a person (such as loader 712). In one or more embodiments or examples, the credential manager system 710 is configured to verify the integrity of a good. In one or more embodiments or examples, the credential manager system 710 is configured to verify the origin of a good. In one or more embodiments or examples, the loader 712 provides first credential data to the remote AV system 701. In some examples, the system 700 is configured such that the vehicle 702 obtains first credential data indicative of one or more first credentials indicative of the item 706. For example, when the loader 712 is loading a food package (such as food package 638 of FIG. 5D) into the vehicle 702, the secure verification system 701a requests first credential data indicative of one or more first credentials indicative of the food package. In some examples, the one or more first credentials indicative of the food package is an employee keycard indicative of a restaurant (such as whitelisted restaurant 636 of FIG. 5D) indicative of the food package (such as the restaurant where the food package was prepared). In other words, the system 700 can be configured such that the vehicle 702 obtains first credential data from the loader 712. The first credential data obtained from the loader 712 by the vehicle 702 can then be provided to the secure verification system 701a. From the secure verification system 701a, the first credential data obtained from the loader 712 by the vehicle 702 can then be provided to the credential manager system 710 for verification and/or authentication. In one or more embodiments or examples, the credential manager system 710 is configured to obtain first credential data indicative of one or more first credentials indicative of the item 706 directly from the loader 712. In one or more embodiments or examples, the credential manager system 710 is configured to verify and/or authenticate the loader 712 and/or item 706 entering the vehicle 702.

In one or more embodiments or examples, the system 700 is configured to verify the one or more credentials by verifying one or more first credentials indicative of the item 706 before and/or at a start of the ride. In some examples, the system 700 is configured to verify the one or more credentials by verifying one or more second credentials indicative of the item 706 after and/or at an end of the ride.

In one or more embodiments or examples, the credential manager system 710 is configured to use the person identification system 710a, goods identification system 710b, and/or entity identification system 710c to verify and/or authenticate the loader 712 and/or item 706 entering the vehicle 702. For example, the person identification system 710a is configured to verify and/or authenticate the loader 712 and/or a person (e.g., such as a passenger). In some examples, the person identification system 710a is configured to verify and/or authenticate the loader 712 and/or a person by obtaining personal credential data. In some examples, goods identification system 710b is configured to verify and/or authenticate one or more goods. In some examples, the goods identification system 710b is configured to verify and/or authenticate the one or more goods by obtaining goods credential data. For example, the entity identification system 710c is configured to verify and/or authenticate an entity. In some example, the entity identification system 710c is configured to verify an entity by obtaining entity credential data.

In one or more embodiments or examples, verifying one or more first credentials indicative of item 706 includes comparing the first credential data indicative of one or more first credentials indicative of the item 706 against the first credential data included in the ride request obtained by the vehicle 702 (such as using AV compute 704). In some examples, when the first credential data obtained by the remote AV system 701 directly from the item 706 matches the first credential data included in the ride request, the system 700 is configured to successfully verify the one or more first credentials indicative of the item 706. For example, the system 700 is configured such that when the ride request obtained by the vehicle 702 from the user device 730 includes facial recognition data, the vehicle 702 obtains facial recognition data of the person indicative of the user device 730 before and/or at the start of the ride. For example, the credential manager system 710 is configured to obtain (e.g., via the secure verification system 701a) the facial recognition data included in the ride request provided by the user device 730 and the facial recognition data obtained by the vehicle 702 before and/or at the start of the ride. In some examples, the credential manager system 710 (e.g., the person identification system 710a) compares the facial recognition data to check if it matches. If the facial recognition data matches, the one or more credentials can be seen as successfully verified.

In one or more embodiments or examples, the system 700 is configured to verify the one or more credentials indicative of the item 706 by obtaining valid credential data from one or more databases and/or servers. In some examples, the database and/or server is indicative of the credential data indicative of one or more credentials indicative of the item 706. In one or more embodiments or examples, the vehicle 702 stores valid credential data indicative of the credential data indicative of one or more credentials indicative of the item 706 using a database (such as database 410 of FIG. 4). In one or more embodiments or examples, verifying one or more first credentials indicative of item 706 includes comparing the first credential data indicative of one or more first credentials indicative of the item 706 against the valid credential data.

In some examples, when the first credential data obtained directly from the item 706 matches the valid credential data obtained from the database and/or server, the one or more first credentials indicative of the item 706 are successfully verified. For example, the system 700 is configured such that the vehicle 702 obtains first credential data (such as label data) indicative of a concert ticket indicative of an item 706. In some examples, the system 700 is configured such that the vehicle 702 obtains valid credential data (such as label data) indicative of a valid concert ticket from a database and/or server (e.g., a database and/or server indicative of the concert ticket verification service). For example, the credential manager system 710 is configured to obtain (e.g., via the secure verification system 701a) first credential data indicative of the one or more first credentials directly from the item 706 and valid credential data from one or more databases and/or servers indicative of the one or more credentials. In some examples, the credential manager system 710 (e.g., the person identification system 710a) can compare the first credential data against the valid credential to check if it matches. If the first credential data matches the valid credential data, the one or more first credentials can be seen as successfully verified.

In one or more embodiments or examples, the credential manager system 710 provides (e.g., communicates) initial authentication status and/or verification status to the secure verification system 701a, the loader 712 (e.g., a user device 730 of the loader 712) and/or the vehicle 702. In one or more embodiments or examples, the credential manager system 710 provides the initial authentication and/or verification status to the user device 730, unloader 708, loader 712 and/or vehicle 702 via the secure verification system 701a. In one or more embodiments or examples, the credential manager system 710 provides the final authentication and/or verification status to the unloader 708 (e.g., to a user device 730 of the unloader 708). In one or more embodiments or examples, the secure verification system 701a is configured to provide (e.g., communicate) the destination to the vehicle 702 (such as to the AV compute 704) and/or to the user device 730 (such as a user device 730 indicative of a passenger of vehicle 702). In some examples, the AV compute 704 (such as using the planning system 404 of FIG. 4 and/or planning system 504a of FIGS. 5B-C) generates route data indicative of a route indicative of the ride by vehicle 702 based on the ride request. In some examples, the AV compute 704 (such using the planning system 404 of FIG. 4 and/or planning system 504a of FIGS. 5B-C) generates route data indicative of a route indicative of the ride in response to receiving (such as from the secure verification system 701a) information indicative of the destination (such as the final destination) of the ride.

In some examples, the secure verification system 701a requests any necessary verification to end the ride. In one or more embodiments or examples, the secure verification system 701a requests any necessary verification to end the ride from the loader 712, the vehicle 702 and/or the item 706 (such as via an interface indicative of the secure verification system 701a).

In one or more embodiments or examples, the credential manager system 710 authenticates and/or verifies the unloader 708 and/or items 706 leaving (such as exiting) the vehicle 702. In one or more embodiments or examples, the unloader 708 provides second credential data to the remote AV system 701. In some examples, the system 700 is configured such that the vehicle 702 obtains second credential data indicative of one or more second credentials indicative of the item 706. For example, when the unloader is unloading a food package (such as food package 638 of FIG. 6D) from the vehicle 702, the secure verification system 701a can request second credential data indicative of one or more second credentials indicative of the food package. In some examples, the one or more second credentials indicative of the food package is an employee keycard associated the unloader 708 (such as unloader 602g). In some examples, the vehicle 702 is configured to obtain the second credential data from the employee keycard indicative of the unloader 708 by scanning a barcode (e.g., using an optical scanner). The second credential data obtained from the unloader 708 by the vehicle 702 can then be provided to the secure verification system 701a. From the secure verification system 701a, the second credential data obtained from the unloader 708 by the vehicle 702 can then be provided to the credential manager system 710 for verification and/or authentication. In one or more embodiments or examples, the system 700 is configured such that the credential manager system 710 obtains second credential data indicative of one or more second credentials indicative of the item 706 directly from the unloader 708 and/or via a user device indicative of the unloader 708. In one or more embodiments or examples, the system 700 is configured such that the credential manager system 710 verifies and/or authenticates the unloader 708 entering the vehicle 702. In one or more embodiments or examples, the system 700 is configured such that the credential manager system 710 uses the person identification system 710a, goods identification system 710b, and/or entity identification system 710c to verify and/or authenticate the unloader 708 entering the vehicle 702. In some examples, the person identification system 710a is configured to verify and/or authenticate the unloader 708 and/or a person by obtaining personal credential data. For example, goods identification system 710b is configured to verify and/or authenticate one or more goods. In some examples, the goods identification system 710b is configured to verify and/or authenticate the one or more goods by obtaining goods credential data. For example, the entity identification system 710c is configured to verify and/or authenticate an entity. In some example, the entity identification system 710c is configured to verify an entity by obtaining entity credential data. In one or more embodiments or examples, verifying one or more second credentials indicative of item 706 includes comparing the second credential data indicative of one or more second credentials indicative of the item 706 against the second credential data included in the ride request obtained by the vehicle 702 (such as using AV compute 704). In other words, the system 700 can be configured such that the credential manager system 710 verifies the second credential data by comparing the second credential data obtained directly from the item 706 and/or unloader 708 against the second credential data included in the ride request obtained from user device 730. In some examples, when the second credential data obtained directly from the item 706 and/or the unloader 708 matches the second credential data included in the ride request, the one or more second credentials indicative of the item 706 are successfully verified.

In one or more embodiments or examples, verifying one or more second credentials indicative of item 706 includes comparing the second credential data indicative of one or more second credentials indicative of the item 706 against the valid credential data obtained from a database and/or server (such as a database and/or server indicative of a secure verification service). In some examples, when the second credential data obtained directly from the item 706 matches the valid credential data obtained from the database and/or server, the one or more second credentials indicative of the item 706 are successfully verified. For example, the system 700 is configured such that the vehicle 702 obtains second credential data (such as label data) indicative of a concert ticket indicative of an item 706 (e.g., a passenger before and/or at the start of the ride (such as using an optical scanner of vehicle 702). For example, the system 700 is configured such that the credential manager system 710 (e.g., via the secure verification system 701a) second credential data indicative of the one or more second credentials directly from the item 706 and valid credential data from one or more databases and/or servers indicative of the one or more credentials. In some examples, the credential manager system 710 (e.g., the person identification system 710a) can compare the second credential data against the valid credential data to check if it matches. If the second credential data matches the valid credential data, the one or more second credentials can be seen as successfully verified. In one or more embodiments or examples, the credential manager system 710 provides (e.g., communicates) final authentication and/or verification status to the secure verification system 701a. In one or more embodiments or examples, the secure verification system 701a provides (e.g., communicate) the final authentication status to the user device 730. In one or more embodiments or examples, the credential manager system 710 provides (e.g., via the secure verification system 701a) the final authentication and/or verification status to the loader 712, user device 730 (e.g., indicative of the unloader 708 and/or loader 712), unloader 708, and/or vehicle 702. For example, when the unloader 708 has unloaded an item 706 (such as confidential documents 624 of FIG. 6C) from the vehicle 702, the secure verification system 701a is configured to provide information indicative of the final authentication status to a user device 730 indicative of the unloader 708. The information indicative of the final authentication status can for example be displayed and/or provided (e.g., to the unloader 708) by an interface indicative of the user device 730. For example, information indicative of the final authentication status can for example be displayed and/or provided (e.g., to the loader 712) as text (e.g., as notification including text).

Referring now to FIG. 8, illustrated is a flowchart of a method or process 800 for attribute verification to enable destination, such as for operating and/or controlling an AV. The method can be performed by a system disclosed herein, such as an AV compute 202f of FIG. 2, AV compute 400 of FIG. 4, vehicle 102, 200, of FIGS. 1 and 2, respectively, device 300 of FIG. 3, and AV compute 504 of FIGS. 5A-D and implementations of FIGS. 6A-D and 7. The system disclosed can include at least one processor which can be configured to carry out one or more of the operations of method 800. The method 800 can be performed (e.g., completely, partially, and/or the like) by another device or group of devices separate from or including system disclosed herein.

A method 800 is disclosed. The method 800 includes obtaining, at step 802, using at least one processor, a ride request requesting a ride for an item from a starting location to a destination. The method 800 includes obtaining, at step 804, using the at least one processor, credential data indicative of one or more credentials indicative of the item. The method 800 includes verifying, at step 806, using the at least one processor, the one or more credentials indicative of the item. The method 800 includes, in response to successful verification of the one or more credentials indicative of the item, generating, at step 808, using the at least one processor, route data indicative of a route indicative of the ride by an autonomous vehicle based on the ride request. The method 800 includes, in response to unsuccessful verification of the one or more credentials indicative of the item, refraining, at step 807, from generating route data indicative of a route indicative of the ride by an autonomous vehicle based on the ride request. In one or more embodiments or examples, the method 800 includes obtaining a ride request from a requestor requesting a ride for an item from a starting location to a destination. In one or more embodiments or examples, the ride includes transporting an item from a starting location to a destination. In one or more embodiments or examples, the method 800 includes obtaining a ride for one or more items. In some examples, the method 800 includes transporting more than one item per ride.

The ride may be seen as a delivery of the item, such as a verified delivery of the item. For example, the item includes one or more people and/or one or more goods. In one or more embodiments or examples, the credential data includes biometric data, identification data, sensor data, image data and/or label data. For example, obtaining credential data indicative of one or more credentials indicative of the item includes obtaining biometric data, identification data, sensor data, image data and/or label data. In some examples, the one or more credentials indicative of the item are credentials indicative of a person, such as a person taking the ride. In one or more embodiments or examples, the one more credentials include initial credentials of a sender indicative of the item, such as indicative of a good. For example, the credentials are credentials indicative of a passenger, loader, unloader, a sender, and/or requestor. The credential indicative of the person can be a passport, fingerprint, keycard, etc. In some examples, the credentials can be credentials indicative of the one or more goods. For example, the credentials indicative of the one or more goods are a label on a package, the weight of a package, etc. In one or more embodiments or examples, the method 800 includes verifying the one or more credentials indicative of the item by comparing the one or more credentials with a database of credentials and determining whether the one or more credentials matches in the database. In one or more embodiments or examples, the method 800 includes generating, in response to successful verification of the one or more credentials indicative of the item, control data based on the route data and cause the AV to operate according to the control data. For example, in response to successful verification of the one or more credentials indicative of the item the method 800 includes causing the AV to start the ride based on the route data and/or the control data.

In one or more embodiments or examples, the one or more credentials includes an identifier indicative of at least one or more of: a person, one or more goods, and an entity. In one or more embodiments or examples verifying, at step S806 the one or more credentials includes verifying one or more of: personal credential data indicative of a person, goods credential data indicative of one or more goods, and entity credential data indicative of an entity. In other words, verifying, at step S806, the one or more credentials includes verifying one or more of: personal credential data indicative of a person, goods credential data indicative of one or more goods, and entity credential data indicative of an entity. In some examples, the method 800 includes verifying the one or more credentials by verifying an identifier indicative of a person, an identifier indicative of one or more goods, and/or an identifier indicative of an entity. For example, the identifier is indicative of a loader, an unloader, a requestor and/or a passenger.

In one or more embodiments or examples, the method 800 further includes providing the route data to cause the autonomous vehicle to operate based on the verification of the one or more credentials. In some examples, once the one or more credentials (such as the one or more first credentials) have been successfully verified, the method 800 includes providing and/or transmitting route data to the control system (such as control system 504b of FIG. 5C-D), such as via the planning system (such as planning system 504a of FIG. 5B-C).

In one or more embodiments or examples, the method 800 further includes triggering, based on the route data, a start of the ride towards the destination upon successful verification of the one or more credentials. In some examples, once the one or more credentials have been successfully verified, the method 800 includes generating control data for the AV to begin driving (e.g., start the ride) towards the destination.

In one or more embodiments or examples, verifying, at step S806 the one or more credentials includes verifying one or more first credentials indicative of the item before and/or at a start of the ride. In one or more embodiments or examples, the first credentials include one or more of: health credentials, access credentials, travel credentials, good credentials, and identification credentials. In some examples, verifying the one or more first credentials can be seen as a preliminary check to ensure that the credentials (such as first credentials) are verified before and/or at the start of the ride but do not change the destination of the ride.

In one or more embodiments or examples, generating, at step S808, the route data includes generating, based on the one or more first credentials, the route data. In some examples, the method 800 includes generating, at step S808, the route data by generating the route data based on one or more of: health credentials, access credentials, travel credentials, good credentials, and identification credentials. In some examples, the method 800 includes generating the route data in response to successful verification of the first credentials. In some examples, the method 800 includes generating the route data by generating route data including a destination (such as an intermediate destination and/or a final destination) indicative of the one or more first credentials.

In one or more embodiments or examples, generating, at step S808, the route data includes updating, based on the one or more first credentials, a final destination of the ride.

In one or more embodiments or examples, verifying, at step S806, the one or more first credentials includes verifying one or more of: biometric data, identification data, sensor data, image data, and label data.

In one or more embodiments or examples, verifying, at step S806, the one or more first credentials includes authenticating a person, verifying integrity of a good, or verifying origin of a good. In some examples, authenticating a person includes verifying the identity of a person. In some examples, the method 800 includes verifying integrity of a good by verifying whether the good is broken or intact and/or whether the good has been tampered with during the ride. In some examples, the method 800 includes verifying origin of a good by verifying whether the origin of the good indicative of the first credentials matches an origin of the good that the ride was requested for.

In one or more embodiments or examples, the method 800 further includes obtaining second credential data indicative of one or more second credentials indicative of the item at or after an end of the ride. In one or more embodiments or examples, the one or more second credentials are different from the one or more first credentials. In one or more embodiments or examples, the method further includes verifying the one or more second credentials. In some examples, the method 800 includes obtaining second credential data indicative of one or more second credentials indicative of the item at or after an end of the ride. In some examples, the second credential data can be seen as credential data indicative of the item at and/or after the end of the ride. For example, the second credential data can be the credential data indicative of the unloading of item from the AV.

In one or more embodiments or examples, the method 800 further includes, in response to successful verification of the one or more second credentials, generating, based on the one or more second credentials, control data for controlling the autonomous vehicle. In some examples, the method 800 includes generating control data for controlling the AV, based on the one or more second credentials, by generating control data to cause the AV to operate based on the successful verification of the second credentials. In some examples, the method 800 includes transmitting the control signal based on control data indicative of ending instructions to the AV (such as the AV compute 504 of FIGS. 5A-D). In some examples, the ending instructions can be indicative of an end of the ride. In one or more embodiments or examples, the method 800 further includes, in response to unsuccessful verification of the one or more second credentials, refraining from generating, control data for controlling the autonomous vehicle.

In one or more embodiments or examples, generating the control data for controlling the autonomous vehicle includes generating control data for controlling access to the autonomous vehicle. In some examples, the method 800 includes generating control data for controlling access to the vehicle by generating control data indicative of a granted access and/or a restricted access.

In one or more embodiments or examples, generating the control data for controlling the autonomous vehicle includes generating control data for controlling navigation of the autonomous vehicle.

In one or more embodiments or examples, the method 800 further includes determining, based on the verification of the one or more second credentials, an authentication status. In one or more embodiments or examples, the method further includes providing the authentication status. In some examples, the method 800 includes providing the authentication status to a server for secure verification and/or a ride service. The authentication status can for example be transmitted via an interface of the credential manager system, such as an interface of the credential manager system 710 of FIG. 7, to an interface of a secure verification system, such as an interface of the secure verification system 701a of FIG. 7.

In one or more embodiments or examples, the method 800 further includes obtaining monitoring data indicative of a monitoring of the item during the ride. In one or more embodiments or examples, the method further includes determining, based on the monitoring data, an item status. In one or more embodiments or examples, the method further includes providing the item status. In some examples, the method 800 includes obtaining monitoring data indicative of a monitoring of the item during the ride such that a chain of custody for the item (e.g., a sensitive item) remains unbroken throughout the ride. In some examples, the method 800 includes providing the item status to a server for secure verification and/or a ride service.

In one or more embodiments or examples, the method 800 further includes obtaining item data indicative of an integrity of the item at start of the ride or during the ride and/or at end of the ride. In one or more embodiments or examples, the method further includes determining, based on the item data or monitoring data, an item status. In some examples, the method 800 includes obtaining item data indicative of whether the good is broken or intact and/or whether the good has been tampered with during the ride. In one or more embodiments or examples, the method 800 further includes providing the item status. In some examples, the method 800 includes providing the item status to a server for secure verification and/or a ride service.

In one or more embodiments or examples, the method 800 further includes determining, based on the item data and/or monitoring data, an item status. In one or more embodiments or examples, the method 800 further includes providing the item status. In some examples, the method 800 includes providing the item status to a server for secure verification and/or a ride service.

In one or more embodiments or examples, the method 800 further includes transmitting, via an interface, the route data to the autonomous vehicle.

In one or more embodiments or examples, the item includes one or more persons and/or one or more goods.

In one or more embodiments or examples, the person is a loader of the item and/or an unloader of the item.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

Disclosed are non-transitory computer readable media comprising instructions stored thereon that, when executed by at least one processor, cause the at least one processor to carry out operations according to one or more of the methods disclosed herein.

Also disclosed are methods, non-transitory computer readable media, and systems according to any of the following items:

Item 1. A method comprising:
obtaining, using at least one processor, a ride request requesting a ride for an item from a starting location to a destination;
obtaining, using the at least one processor, credential data indicative of one or more credentials, where the one or more credentials are indicative of the item;
verifying, using the at least one processor, the one or more credentials; and
in response to successful verification of the one or more credentials indicative of the item, generating, using the at least one processor, route data indicative of a route based on the ride request, where the route is indicative of the ride by an autonomous vehicle.
   Item 2. The method according to item 1, wherein:
the one or more credentials comprises an identifier indicative of at least one or more of: a person, one or more goods, and an entity; and
verifying the one or more credentials comprises:
   verifying one or more of: personal credential data indicative of a person, goods credential data indicative of one or more goods, and entity credential data indicative of an entity.
      Item 3. The method according to any of the previous items, the method further comprising:
providing the route data to cause the autonomous vehicle to operate based on the verification of the one or more credentials.
   Item 4. The method according to any of the previous items, the method further comprising:
triggering a start of the ride towards the destination upon successful verification of the one or more credentials based on the route data.
   Item 5. The method according to any of the previous items, wherein verifying the one or more credentials comprises verifying one or more first credentials indicative of the item before or at a start of the ride, and wherein the first credentials comprise one or more of: health credentials, access credentials, travel credentials, good credentials, and identification credentials.
   Item 6. The method according to item 5, wherein generating the route data comprises generating the route data based on the one or more first credentials.
   Item 7. The method according to any of items 5-6, wherein generating the route data comprises updating a final destination of the ride based on the one or more first credentials.
   Item 8. The method according to any of items 5-7, wherein verifying the one or more first credentials comprises verifying one or more of: biometric data, identification data, sensor data, image data, and label data.
   Item 9. The method according to any of items 5-8, wherein verifying the one or more first credentials comprises authenticating a person, verifying integrity of a good, or verifying origin of a good.
   Item 10. The method according to any of the previous items, the method further comprising:
obtaining second credential data indicative of one or more second credentials indicative of the item at or after an end of the ride, wherein the one or more second credentials are different from the one or more first credentials; and
verifying the one or more second credentials.
   Item 11. The method according to item 10, the method further comprising:
in response to successful verification of the one or more second credentials, generating control data for controlling the autonomous vehicle based on the one or more second credentials.
   Item 12. The method according to item 11, wherein generating the control data for controlling the autonomous vehicle comprises generating control data for controlling access to the autonomous vehicle.
   Item 13. The method according to any of items 11-12, wherein generating the control data for controlling the autonomous vehicle comprises generating control data for controlling navigation of the autonomous vehicle.
   Item 14. The method according to any of items 10-13, wherein the method further comprising:
determining an authentication status based on the verification of the one or more second credentials; and
providing the authentication status to a device.
   Item 15. The method according to any of the previous items, the method further comprising:
obtaining monitoring data indicative of a monitoring of the item during the ride;
determining an item status based on the monitoring data; and
providing the item status to a device.
   Item 16. The method according to any of the previous items, the method further comprising:
obtaining item data indicative of an integrity of the item at start of the ride or during the ride and/or at end of the ride;
determining an item status based on the item data or monitoring data; and
providing the item status to a device.
   Item 17. The method according to any of items 15-16, the method further comprising:
determining an item status based on the item data and/or monitoring data; and
providing the item status to the device.
   Item 18. The method according to any of the previous items, the method further comprising
transmitting the route data to the autonomous vehicle via the interface.
   Item 19. The method according to any of items 1-17, the method further comprising:
foregoing transmitting the route data to the autonomous vehicle based on the verification of the one or more credentials.
   Item 20. The method according to any of the previous items, wherein the item comprises one or more persons and/or one or more goods.
   Item 21. The method according to item 19, wherein the person is a loader of the item or an unloader of the item.
   Item 22. A system comprising:
at least one processor; and
at least one non-transitory computer readable medium storing instructions that, when executed by the at least one processor, cause the at least one processor to perform operations comprising:
   obtaining a ride request requesting a ride for an item from a starting location to a destination using at least one processor;
   obtaining credential data indicative of one or more credentials indicative of the item using the at least one processor;
   verifying the one or more credentials indicative of the item using the at least one processor; and
   in response to successful verification of the one or more credentials indicative of the item, generating route data indicative of a route indicative of the ride by an autonomous vehicle based on the ride request using the at least one processor.
      Item 23. The system according to item 22, wherein:
the one or more credentials comprises an identifier indicative of at least one or more of: a person, one or more goods, and an entity; and
verifying the one or more credentials comprises:
verifying one or more of: personal credential data indicative of a person, goods credential data indicative of one or more goods, and entity credential data indicative of an entity.
   Item 24. The system according to any of items 22-23, the operations further comprising:
providing the route data to cause the autonomous vehicle to operate based on the verification of the one or more credentials.
   Item 25. The system according to any of items 22-24, the operations further comprising:
triggering, based on the route data, a start of the ride towards the destination upon successful verification of the one or more credentials.
   Item 26. The system according to any of items 22-25, wherein verifying the one or more credentials comprises verifying one or more first credentials indicative of the item before and/or at a start of the ride, and wherein the first credentials comprise one or more of: health credentials, access credentials, travel credentials, good credentials, and identification credentials.
   Item 27. The system according to item 26, wherein generating the route data comprises generating, based on the one or more first credentials, the route data.
   Item 28. The system according to any of items 26-27, wherein generating the route data comprises updating, based on the one or more first credentials, a final destination of the ride.
   Item 29. The system according to any of items 26-28, wherein verifying the one or more first credentials comprises verifying one or more of: biometric data, identification data, sensor data, image data, and label data.
   Item 30. The system according to any of items 5-8, wherein verifying the one or more first credentials comprises authenticating a person, verifying integrity of a good, or verifying origin of a good.
   Item 31. The system according to any of items 22-30, the operations further comprising:
obtaining second credential data indicative of one or more second credentials indicative of the item at or after an end of the ride, wherein the one or more second credentials are different from the one or more first credentials; and
verifying the one or more second credentials.
   Item 32. The system according to item 31, the operations further comprising:
in response to successful verification of the one or more second credentials, generating, based on the one or more second credentials, control data for controlling the autonomous vehicle.
   Item 33. The system according to item 32, wherein generating the control data for controlling the autonomous vehicle comprises generating control data for controlling access to the autonomous vehicle.
   Item 34. The system according to any of items 32-33, wherein generating the control data for controlling the autonomous vehicle comprises generating control data for controlling navigation of the autonomous vehicle.
   Item 35. The system according to any of items 31-34, wherein the operations further comprise:
determining, based on the verification of the one or more second credentials, an authentication status; and
providing the authentication status.
   Item 36. The system according to any of items 22-35, the operations further comprising:
obtaining monitoring data indicative of a monitoring of the item during the ride;
determining, based on the monitoring data, an item status; and
providing the item status.
   Item 37. The system according to any of items 22-36, the operations further comprising:
obtaining item data indicative of an integrity of the item at start of the ride or during the ride and/or at end of the ride;
determining, based on the item data or monitoring data, an item status; and
providing the item status.
   Item 38. The system according to any of items 36-38, the operations further comprising:
determining, based on the item data and/or monitoring data, an item status; and
providing the item status.
   Item 39. The system according to any of items 22-38, the operations further comprising transmitting, via an interface, the route data to the autonomous vehicle.
   Item 40. The system according to any of items 22-39, wherein the item comprises one or more persons and/or one or more goods.
   Item 41. The system according to item 40, wherein the person is a loader of the item or an unloader of the item.
   Item 42. A non-transitory computer readable medium comprising instructions stored thereon that, when executed by at least one processor, cause the at least one processor to carry out operations comprising:
obtaining a ride request requesting a ride for an item from a starting location to a destination using at least one processor;
obtaining credential data indicative of one or more credentials indicative of the item using the at least one processor;
verifying the one or more credentials indicative of the item using the at least one processor; and
in response to successful verification of the one or more credentials indicative of the item, generating route data indicative of a route indicative of the ride by an autonomous vehicle based on the ride request using the at least one processor.

1. A method comprising:
obtaining, using at least one processor, a ride request requesting a ride for an item from a starting location to a destination;
obtaining, using the at least one processor, credential data indicative of one or more credentials, the one or more credentials indicative of the item;
verifying, using the at least one processor, the one or more credentials; and
in response to successful verification of the one or more credentials, generating, using the at least one processor, route data indicative of a route based on the ride request, the route indicative of the ride by an autonomous vehicle.

2. The method according to claim 1, wherein:
the one or more credentials comprises an identifier indicative of at least one or more of: a person, one or more goods, and an entity; and
verifying the one or more credentials comprises:
verifying one or more of: personal credential data indicative of a person, goods credential data indicative of one or more goods, and entity credential data indicative of an entity.

3. The method according to claim 1, the method further comprising:
providing the route data to cause the autonomous vehicle to operate based on the verification of the one or more credentials.

4. The method according to claim 1, the method further comprising:
triggering a start of the ride towards the destination upon successful verification of the one or more credentials based on the route data.

5. The method according to claim 1, wherein verifying the one or more credentials comprises verifying one or more first credentials indicative of the item before or at a start of the ride, and
wherein the first credentials comprise one or more of: health credentials, access credentials, travel credentials, good credentials, and identification credentials.

6. The method according to claim 5, wherein generating the route data comprises generating the route data based on the one or more first credentials.

7. The method according to claim 5, wherein generating the route data comprises updating a final destination of the ride based on the one or more first credentials.

8. The method according to claim 5, wherein verifying the one or more first credentials comprises verifying one or more of: biometric data, identification data, sensor data, image data, and label data.

9. The method according to claim 6, wherein verifying the one or more first credentials comprises authenticating a person, verifying integrity of a good, or verifying origin of a good.

10. The method according to claim 1, the method further comprising:
obtaining second credential data indicative of one or more second credentials, the one or more second credentials indicative of the item at or after an end of the ride, wherein the one or more second credentials are different from the one or more first credentials; and
verifying the one or more second credentials.

11. The method according to claim 10, the method further comprising:
in response to successful verification of the one or more second credentials, generating control data for controlling the autonomous vehicle based on the one or more second credentials.

12. The method according to claim 11, wherein generating the control data for controlling the autonomous vehicle comprises generating control data for controlling access to the autonomous vehicle.

13. The method according to claim 11, wherein generating the control data for controlling the autonomous vehicle comprises generating control data for controlling navigation of the autonomous vehicle.

14. The method according to claim 10, the method further comprising:
determining an authentication status based on the verification of the one or more second credentials; and
providing the authentication status to a device.

15. The method according to claim 1, the method further comprising:
obtaining monitoring data indicative of a monitoring of the item during the ride;
determining an item status based on the monitoring data; and
providing the item status to a device.

16. The method according to claim 1, the method further comprising:
obtaining item data indicative of an integrity of the item at start of the ride or during the ride and/or at end of the ride;
determining an item status based on the item data or monitoring data; and
providing the item status to a device.

17. The method according to claim 15, the method further comprising:
determining an item status based on the item data and/or monitoring data; and
providing the item status to the device.

18. The method according to claim 1, the method further comprising
transmitting the route data to the autonomous vehicle via the interface.

19. The method according to claim 1, the method further comprising:
foregoing transmitting the route data to the autonomous vehicle based on the verification of the one or more credentials.

20. The method according to claim 1, wherein the item comprises one or more persons and/or one or more goods.

21. The method according to claim 20, wherein the person is a loader of the item or an unloader of the item.

22. A system comprising:
at least one processor; and
at least one non-transitory computer readable medium storing instructions that, when executed by the at least one processor, cause the at least one processor to perform operations comprising:
obtaining a ride request requesting a ride for an item from a starting location to a destination using at least one processor;
obtaining credential data indicative of one or more credentials indicative of the item using the at least one processor;
verifying the one or more credentials indicative of the item using the at least one processor; and
in response to successful verification of the one or more credentials indicative of the item, generating route data indicative of a route indicative of the ride by an autonomous vehicle based on the ride request using the at least one processor.

23. A non-transitory computer readable medium comprising instructions stored
thereon that, when executed by at least one processor, cause the at least one processor to carry out operations comprising:
obtaining a ride request requesting a ride for an item from a starting location to a destination using at least one processor;
obtaining credential data indicative of one or more credentials indicative of the item using the at least one processor;
verifying the one or more credentials indicative of the item using the at least one processor; and
in response to successful verification of the one or more credentials indicative of the item, generating route data indicative of a route indicative of the ride by an autonomous vehicle based on the ride request using the at least one processor.
